(19) United States
(12) Patent Application Publication
(10) Pub. No.: US 2023/0156818 A1
(43) Pub. Date: May 18, 2023

(54) Random Access in a Wireless Communication Network

(71) Applicant: Telefonaktiebolaget LM Ericsson (publ), Stockholm (SE)

(72) Inventors: Min Wang, Luleå (SE); Jan Christoffersson, Luleå (SE); Robert Mark Harrison, Grapevine, TX (US); Zhipeng Lin, Nanjing Jiangsu (CN); Johan Rune, Lidingö (SE); Henrik Enbuske, Stockholm (SE)

(21) Appl. No.: 17/917,026

(22) PCT Filed: Apr. 7, 2021
(86) PCT No.: PCT/EP2021/059012

§ 371 Date: Oct. 5, 2022

(30) Foreign Application Priority Data
Apr. 7, 2020 (CN) PCT/CN2020/083560

(51) Int. Cl. H04W 74/08

(52) U.S. Cl. CPC H04W 74/0841; H04W 74/0866

(57) ABSTRACT

A wireless device (40) determines that no resources configured for random access on a link support a minimum gap requirement of the wireless device (40), where the minimum gap requirement is a minimum gap required in time between an end of a transmission of a random access preamble (16) and a start of a transmission of a payload (18). Based on this determination, the wireless device either (i) transmits a random access preamble (16) using the resources configured for random access on the link, but waits to transmit a payload (18) until the wireless device (40) receives a random access response in response to the random access preamble (16); (ii) delays random access on the link until resources configured for random access on the link support the minimum gap requirement of the wireless device (40); or (iii) selects to perform random access on a different link.

### TECHNICAL FIELD

The present application relates generally to a wireless communication network, and relates more particularly to random access in such a network.

### BACKGROUND

Random access in a wireless communication system involves a wireless device (e.g., a user equipment, UE) transmitting a random access preamble to a radio network node (e.g., a base station) over a random access channel. After transmitting the preamble, the wireless device in a so-called two-step random access procedure may proactively transmit a payload on a physical uplink shared channel (PUSCH), even before the wireless device receives a random access response from the radio network node in response to the preamble.

Some contexts complicate this 2-step random access procedure. For example, if the 2-step random access procedure is performed for random access to a link deployed in unlicensed frequency spectrum, a wireless device may need to perform a listen-before-talk (LBT) procedure both before the preamble transmission and before the payload transmission. However, if the gap in time between the preamble and the payload is less than a certain threshold (e.g., 16 us), the wireless device need only perform a single LBT procedure before the preamble transmission, i.e., without having to perform another LBT procedure before the payload transmission. This “gapless” message transmission approach, in which the gap in time between the preamble and the payload is less than the certain threshold, reduces random access latency by avoiding multiple LBT procedures. Problematically, though, different radio network nodes may differ in their support for gapless message transmission or in their configuration of resources on a link usable for gapless message transmission. Moreover, some wireless devices may differ in terms of how quickly they are able to transmit the payload after transmitting the preamble, e.g., lower-end devices may not have hardware as capable as higher-end devices for quick transition between signals with different power levels. Challenges exist therefore in exploiting 2-step random access with gapless message transmission in the face of differing device capabilities and network configurations.

### SUMMARY

According to some embodiments herein, a radio network node transmits signaling indicating whether or not gapless message transmission is configured for random access on a link. A wireless device can then perform random access on the link based on this signaling, e.g., including determining whether or not to use gapless message transmission. This way, the wireless device may use gapless message transmission for random access on the link if the link is configured for gapless message transmission and if the wireless device itself is capable of gapless message transmission. Alternatively, the wireless device can perform link selection based on the received signaling, e.g., to select a link in dependence on whether gapless message transmission is configured for random access on the link.

More particularly, embodiments herein include a method performed by a wireless device. The method comprises determining that no resources configured for random access on a link support a minimum gap requirement of the wireless device. This minimum gap requirement is a minimum gap required in time between an end of a transmission of a random access preamble and a start of a transmission of a payload. The method further comprises, based on said determining, transmitting a random access preamble using the resources configured for random access on the link, but waiting to transmit a payload until the wireless device receives a random access response in response to the random access preamble. Alternatively, the method further comprises, based on said determining, delaying random access on the link until resources configured for random access on the link support the minimum gap requirement of the wireless device. Alternatively, the method further comprises, based on said determining, selecting to perform random access on a different link.

In some embodiments, said transmitting, delaying, or selecting comprises transmitting a random access preamble using the resources configured for random access on the link, but waiting to transmit a payload until the wireless device receives a random access response in response to the random access preamble. In one or more of these embodiments, waiting to transmit a payload until the wireless device receives a random access response in response to the random access preamble comprises discarding a payload prepared for transmission as part of a 2-step random access procedure. Alternatively or additionally, said determining comprises determining that no resources configured for random access on the link support a minimum gap requirement needed for the wireless device to perform a 2-step random access procedure. In this case, said transmitting comprises transmitting, based on said determining, a 4-step random access preamble.

In one or more embodiments, the method further comprises selecting a random access preamble resource in which to transmit a random access preamble, irrespective of whether the random access preamble resource is configured for a 2-step random access preamble or a 4-step random access preamble. In this case, said determining is performed after selecting a random access preamble resource configured for a 2-step random access preamble.

In other embodiments, the method further comprises selecting a random access preamble resource configured for a 2-step random access preamble, wherein said determining is performed after said selecting.

In still other embodiments, the transmitted random access preamble is a 2-step random access preamble and the random access response is a fallback random access response. In one or more of these embodiments, the method further comprises selecting to perform a 4-step random access procedure for random access on the link, and after selecting to perform the 4-step random access procedure, determining that no resources are configured on the link for a 4-step random access procedure. The method in this case also comprises selecting to transmit a 2-step random access preamble based on said determining that no resources are configured on the link for a 4-step random access procedure, and after selecting to transmit a 2-step random access preamble, determining whether resources configured for random access on the link support the minimum gap requirement of the wireless device.

In some embodiments, said determining that no resources configured for random access on the link support the minimum gap requirement of the wireless device comprises, for each combination of a random access preamble resource and a payload resource configured for random access on the link, determining that a gap in time between an end of the random access preamble resource and a start of the payload resource is less than the minimum gap requirement of the wireless device.

In one or more embodiments, said transmitting, delaying, or selecting comprises said delaying or said selecting.

In some embodiments, the link is a cell or a bandwidth part of a cell, and the link is deployed on an unlicensed frequency carrier.

Other embodiments herein include a method performed by a wireless device. The method comprises determining whether and/or which resources configured for random access on a link support a minimum gap requirement of the wireless device and/or a maximum gap requirement for gapless message transmission. In this case, the minimum gap requirement is a minimum gap required in time between an end of a transmission of a random access preamble and a start of a transmission of a payload, and according to the maximum gap requirement a gap in time, if any, between an end of a transmission of a random access preamble and a start of a transmission of a payload must be less than or equal to a maximum gap threshold. The method also comprises based on said determining, deciding whether and/or how to perform random access on the link. The method also comprises performing or not performing random access on the link according to said deciding.

In some embodiments, said deciding comprises selecting which resources to use for performing random access on the link, and said performing comprises performing random access on the link using the selected resources.

In some embodiments, said deciding comprises selecting which random access preamble to use for performing random access on the link, and said performing comprises transmitting the selecting random access preamble.

In some embodiments, said deciding comprises deciding whether and/or how to use gapless message transmission for random access on the link, and said performing or not performing comprises using or not using gapless message transmission for random access on the link according to said deciding.

In some embodiments, said deciding comprises deciding whether to use a 2-step procedure or a 4-step procedure for random access on the link, and said performing or not performing comprises using the 2-step procedure or the 4-step procedure for random access on the link according to said deciding.

In some embodiments, the link is a cell or a bandwidth part of a cell, and the link is deployed on an unlicensed frequency carrier.

Other embodiments herein include a wireless device configured to determine that no resources configured for random access on a link support a minimum gap requirement of the wireless device. In this case, the minimum gap requirement is a minimum gap required in time between an end of a transmission of a random access preamble and a start of a transmission of a payload. The wireless device is also configured to, based on determining that no resources configured for random access on the link support the minimum gap requirement of the wireless device, transmit a random access preamble using the resources configured for random access on the link, but waiting to transmit a payload until the wireless device receives a random access response in response to the random access preamble. Alternatively, the wireless device is also configured to, based on determining that no resources configured for random access on the link support the minimum gap requirement of the wireless device, delay random access on the link until resources configured for random access on the link support the minimum gap requirement of the wireless device. Alternatively, the wireless device is also configured to, based on determining that no resources configured for random access on the link support the minimum gap requirement of the wireless device, select to perform random access on a different link.

In some embodiments, the wireless device is configured to perform the steps described above for a wireless device.

Other embodiments herein include a wireless device configured to make a determination as to whether and/or which resources configured for random access on a link support a minimum gap requirement of the wireless device and/or a maximum gap requirement for gapless message transmission. In this case, the minimum gap requirement is a minimum gap required in time between an end of a transmission of a random access preamble and a start of a transmission of a payload, and according to the maximum gap requirement a gap in time, if any, between an end of a transmission of a random access preamble and a start of a transmission of a payload must be less than or equal to a maximum gap threshold. The wireless device is also configured to, based on the determination, make a decision as to whether and/or how to perform random access on the link. The wireless device is also configured to perform or not perform random access on the link according to the decision.

In some embodiments, the wireless device is configured to perform the steps described above for a wireless device.

Other embodiments herein include a computer program comprising instructions which, when executed by at least one processor of a wireless device, causes the wireless device to perform the steps described above for a wireless device.

In some embodiments, a carrier containing the computer program described above is one of an electronic signal, optical signal, radio signal, or computer readable storage medium.

Other embodiments herein include a wireless device comprising communication circuitry and processing circuitry. The processing circuitry is configured to determine that no resources configured for random access on a link support a minimum gap requirement of the wireless device. In this case, the minimum gap requirement is a minimum gap required in time between an end of a transmission of a random access preamble and a start of a transmission of a payload. The processing circuitry is configured to, based on determining that no resources configured for random access on the link support the minimum gap requirement of the wireless device, transmit a random access preamble using the resources configured for random access on the link, but waiting to transmit a payload until the wireless device receives a random access response in response to the random access preamble. Alternatively, the processing circuitry is configured to, based on determining that no resources configured for random access on the link support the minimum gap requirement of the wireless device, delay random access on the link until resources configured for random access on the link support the minimum gap requirement of the wireless device. Alternatively, the processing circuitry is configured to, based on determining that no resources configured for random access on the link support the minimum gap requirement of the wireless device, select to perform random access on a different link.

In some embodiments, the processing circuitry configured to perform the steps described above for a wireless device.

Other embodiments herein include a wireless device comprising communication circuitry and processing circuitry. The processing circuitry is configured to make a determination as to whether and/or which resources configured for random access on a link support a minimum gap requirement of the wireless device and/or a maximum gap requirement for gapless message transmission. In this case, the minimum gap requirement is a minimum gap required in time between an end of a transmission of a random access preamble and a start of a transmission of a payload, and according to the maximum gap requirement a gap in time, if any, between an end of a transmission of a random access preamble and a start of a transmission of a payload must be less than or equal to a maximum gap threshold. The processing circuitry is also configured to, based on the determination, make a decision as to whether and/or how to perform random access on the link. The processing circuitry is also configured to perform or not perform random access on the link according to the decision.

In some embodiments, the processing circuitry configured to perform the steps described above for a wireless device.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of a wireless communication network according to other embodiments.

FIG. 3 is a block diagram of a wireless communication network according to still other embodiments.

FIG. 4A is a method performed by a wireless device according to some embodiments.

FIG. 4B is a method performed by a radio network node according to some embodiments.

FIG. 5A is a method performed by a wireless device according to other embodiments.

FIG. 5B is a method performed by a radio network node according to other embodiments.

FIG. 6 is a method performed by a wireless device according to still other embodiments.

FIG. 7 is a method performed by a wireless device according to yet other embodiments.

FIG. 8 is a method performed by a radio network node according to still other embodiments.

FIG. 9 is a block diagram of a wireless device according to some embodiments.

FIG. 10 is a block diagram of a radio network node according to some embodiments.

FIG. 11 is a call flow diagram of a 4-step random access procedure.

FIG. 12 is a call flow diagram of a 2-step random access procedure.

FIG. 13A is a call flow diagram of preamble assignment for a contention-free 4-step random access procedure.

FIG. 13B is a call flow diagram of preamble assignment for a contention-free 2-step random access procedure.

FIG. 14 is a block diagram of RACH occasion and PUSCH occasion resource configuration according to some embodiments.

FIG. 15 is a block diagram of a wireless communication network according to some embodiments.

FIG. 16 is a block diagram of a user equipment according to some embodiments.

FIG. 17 is a block diagram of a virtualization environment according to some embodiments.

FIG. 18 is a block diagram of a communication network with a host computer according to some embodiments.

FIG. 19 is a block diagram of a host computer according to some embodiments.

FIG. 20 is a flowchart illustrating a method implemented in a communication system, in accordance with one embodiment.

FIG. 21 is a flowchart illustrating a method implemented in a communication system, in accordance with one embodiment.

FIG. 22 is a flowchart illustrating a method implemented in a communication system, in accordance with one embodiment.

FIG. 23 is a flowchart illustrating a method implemented in a communication system, in accordance with one embodiment.

### DETAILED DESCRIPTION

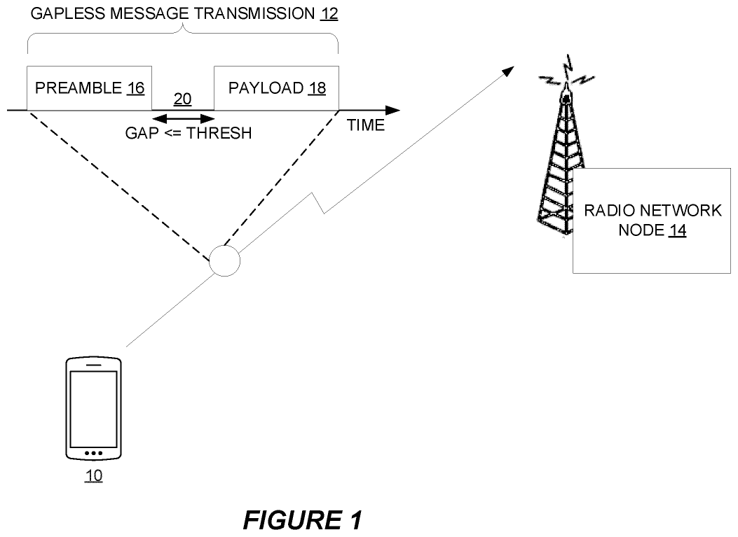

FIG. 1 shows a wireless device 10 performing gapless message transmission 12 for random access to a link (e.g., a cell or bandwidth part, BWP) provided by a radio network node 14 according to some embodiments. The gapless message transmission 12 may for instance be performed as part of a 2-step random access procedure, e.g., in which case the gapless message transmission 12 may be referred to as gapless msgA transmission. The wireless device 10 according to the gapless message transmission 12 transmits a random access preamble 16, e.g., in a random access preamble resource. The wireless device 10 also transmits a payload 18, e.g., on a Physical Uplink Shared Channel (PUSCH), such as a Radio Resource Control (RRC) session establishment or resume request. The gapless message transmission 12 is gapless in the sense that any gap 20 in time between an end of the random access preamble 16 and a start of the payload 18 is less than or equal to a maximum gap threshold, e.g., 16 us. In this regard, if there is a non-zero gap in time between the preamble 16 and the payload 18, the gap 20 being less than the maximum gap threshold may mean that the transmission 12 can be treated as if there was no gap between the preamble 16 and the payload 18. That is, a transmission 12 with a non-zero gap less than the maximum gap threshold is still effectively deemed or treated as a transmission without any gap, i.e., a gapless message transmission. The maximum gap threshold may also be referred to as a maximum gap requirement since it is the maximum gap permitted in time for the transmission to be considered a gapless message transmission.

Where the gapless message transmission 12 is performed on a link deployed in unlicensed frequency spectrum, for instance, the transmission 12 being effectively gapless in nature may mean that the wireless device 10 need only perform a single listen-before-talk (LBT) procedure before transmitting the preamble 16, and need not perform another LBT procedure before transmitting the payload 18. This is because the preamble transmission is considered to still control the channel if the wireless device 10 occupies the channel again with the payload transmission before expiry of the maximum gap threshold.

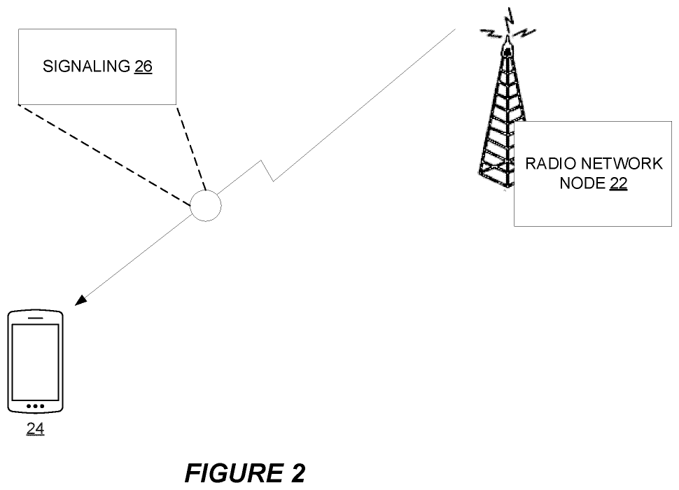

In this context, FIG. 2 shows a radio network node 22 according to some embodiments is configured to transmit signaling 26 (e.g., broadcasted system information) to a wireless device 24. The signaling 26 indicates whether or not gapless message transmission 12 is configured for random access on a link. As explained above, according to gapless message transmission 12 a gap 20 in time, if any, between an end of a transmission of a random access preamble 16 and a start of a transmission of a payload 18 is less than or equal to a maximum gap threshold. The wireless device 24 correspondingly receives this signaling 26. In some embodiments, the wireless device 24 performs random access on the link based on this signaling 26. For example, the wireless device may determine, based at least in part on the received signaling 26, whether or not to use gapless message transmission 12 for random access on the link. This determination may also be based on whether or not the wireless device 24 is capable of gapless message transmission 12 for random access, e.g., where the device's capability may depend on whether its hardware or other capability supports being able to transition from transmitting the preamble 16 to transmitting the payload 18 in less time than the maximum gap threshold.

In some embodiments, for example, the wireless device 24 is configured to use gapless message transmission 20 for random access on the link if the signaling 26 indicates that gapless message transmission 20 is configured for random access on the link and the wireless device 24 is capable of gapless message transmission 20 for random access. But, the wireless device 24 is configured to not use gapless message transmission 20 for random access on the link if the signaling 26 indicates that gapless message transmission 20 is not configured for random access on the link or the wireless device 24 is not capable of gapless message transmission 20 for random access. If the wireless device 24 does not use gapless message transmission 20, for instance, the wireless device 24 may wait to transmit a payload (e.g., RRC establishment request) until after receiving a random access response in response to the preamble 16. That is, the wireless device 24 may receive a random access response in response to the preamble, and only then transmit a payload after receiving the response.

In other embodiments, the wireless device 24 determines, based on the received signaling 24, whether to perform random access on the link. This may be performed as part of link selection, for instance. In one such embodiment, the wireless device selects, from one or more candidate links, a link on which to perform random access, according to link selection criteria that favors links in the following order: (1) a link with the best downlink signal measurement and on which gapless message transmission is configured for random access; (2) a link on which gapless message transmission is not configured for random access but which has the best downlink signal measurement and is configured for a 2-step random access procedure; and (3) a link on which gapless message transmission is not configured for random access and which is not configured for a 2-step random access procedure, but which has the best downlink signal measurement. In other embodiments, the wireless device 24 may determine, based on the signaling 26, how or whether to offset a signal measurement on the link, and then decide whether or not to perform random access on the link based on the potentially offset signal measurement.

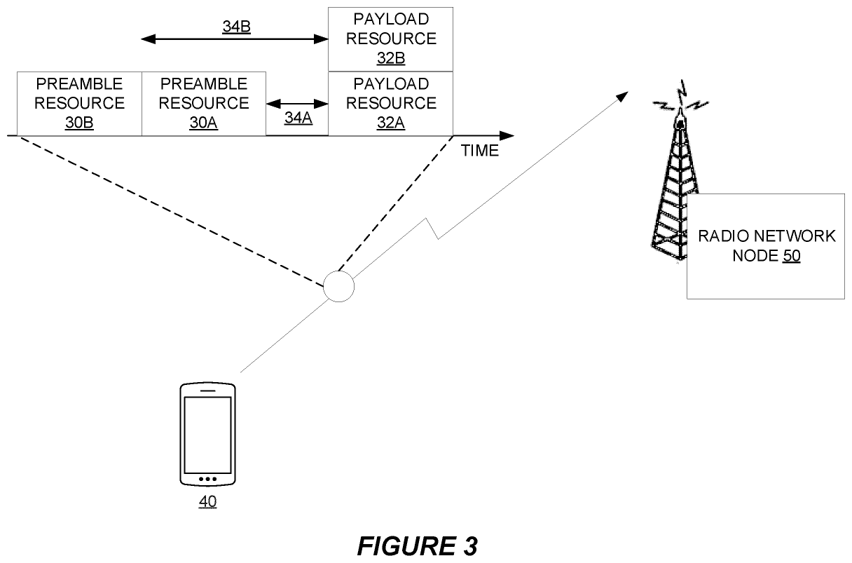

FIG. 3 illustrates additional or alternative embodiments herein. As shown, resources are configured for random access on a link served by radio network node 50. The resources shown include for example preamble resources 30A and 30B for transmission of a random access preamble, and payload resources 32A and 32B for transmission of a payload. The resources may be paired in the sense that selection of preamble resource 30A for transmission of the random access preamble requires selection of payload resource 32A for transmission of the payload. And selection of preamble resource 30B for transmission of the random access preamble requires selection of payload resource 32B for transmission of the payload.

In this context, according to some embodiments, a wireless device 40 determines whether and/or which resources (e.g., resources 30A, 30B, 32A, 32B, etc.) configured for random access on the link support a minimum gap requirement of the wireless device 40 and/or a maximum gap requirement for gapless message transmission 20. Determining whether and/or which resources support the maximum gap requirement may for instance involve determining whether and/or which pair(s) or resources are separated in time by a gap that is less than or equal to the maximum gap requirement for gapless message transmission 20. As shown, for instance, this may involve determining whether the gap 34A between preamble resource 30A and payload resource 32A is less than or equal to the maximum gap requirement, and/or determining whether the gap 34B between preamble resource 30B and payload resource 32B is less than or equal to the maximum gap requirement. On the other hand, the minimum gap requirement of the wireless device 40 may reflect a hardware limitation or other limitation of the wireless device 40 which prevents the wireless device 40 from transmitting the payload too quickly after transmitting the preamble. Accordingly, determining whether and/or which resources support the minimum gap requirement may for instance involve determining whether and/or which pair(s) or resources are separated in time by a gap that is greater than or equal to the minimum gap requirement. As shown, for instance, this may involve determining whether the gap 34A between preamble resource 30A and payload resource 32A is greater than or equal to the minimum gap requirement, and/or determining whether the gap 34B between preamble resource 30B and payload resource 32B is greater than or equal to the minimum gap requirement.

In some embodiments, the wireless device 40, based on this determination, decides whether and/or how to perform random access on the link. The wireless device 40 may then perform or not perform random access on the link according to that decision. For example, the wireless device 40 may select which resources to use for performing random access on the link, may select which random access preamble to use for performing random access on the link (e.g., a 2-step random access preamble or a 4-step random access preamble), may decide whether and/or how to use gapless message transmission 20 for random access on the link, and/or may decide whether to use a 2-step procedure or a 4-step procedure for random access on the link.

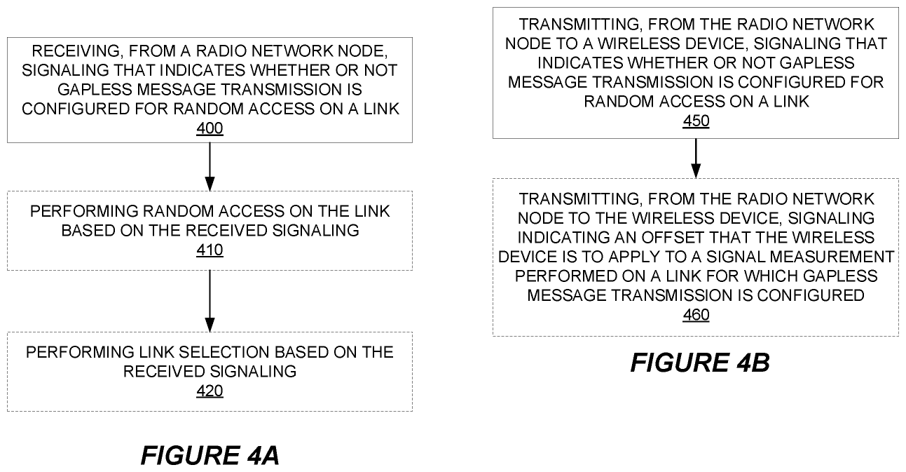

In view of the modifications and variations herein, FIG. 4A shows a method performed by a wireless device 24. The method comprises receiving, from a radio network node 22, signaling 26 that indicates whether or not gapless message transmission 12 is configured for random access on a link (Block 400). Here, according to gapless message transmission 12 a gap 20 in time, if any, between an end of a transmission of a random access preamble 16 and a start of a transmission of a payload 18 is less than or equal to a maximum gap threshold.

In some embodiments, the method also comprises performing random access on the link based on the received signaling 26 (Block 410). This performing may, for example, comprise determining, based at least in part on the received signaling 26, whether or not to use gapless message transmission 12 for random access on the link. In one or more embodiments, such determining is also based on whether or not the wireless device 24 is capable of gapless message transmission 12 for random access. In this case, performing random access may comprise using gapless message transmission 12 for random access on the link if the signaling 26 indicates that gapless message transmission 12 is configured for random access on the link and the wireless device 24 is capable of gapless message transmission 12 for random access. Or, performing random access may instead comprise not using gapless message transmission 12 for random access on the link if the signaling 26 indicates that gapless message transmission 12 is not configured for random access on the link or the wireless device 24 is not capable of gapless message transmission 12 for random access.

In other embodiments, performing random access comprises, based on the signaling 26 indicating that gapless message transmission 12 is not configured for random access on the link or based on the wireless device 24 not being capable of gapless message transmission 12 for random access: (i) transmitting a random access preamble for random access on the link; (ii) receiving a random access response in response to the transmitted random access preamble; and (iii) transmitting a payload after receiving the random access response. In one such embodiment, the transmitted random access preamble is specific for a 4-step random access procedure. In another embodiment, by contrast, the transmitted random access preamble is specific for a 2-step random access procedure.

In some embodiments, the method further comprises determining, based on the received signaling 26, whether to perform random access on the link.

In yet other embodiments, the method alternatively or additionally comprises performing link selection based on the received signaling 26 (Block 420). For example, performing link selection based on the received signaling 26 may comprise selecting, from one or more candidate links, a link on which to perform random access, according to link selection criteria that favors links in the following order: (i) a link with the best downlink signal measurement and on which gapless message transmission 12 is configured for random access; (ii) a link on which gapless message transmission 12 is not configured for random access but which has the best downlink signal measurement and is configured for a 2-step random access procedure; and (iii) a link on which gapless message transmission 12 is not configured for random access and which is not configured for a 2-step random access procedure, but which has the best downlink signal measurement.

In some embodiments, the method further comprises performing a signal measurement on the link. In this case, the method may also comprise, based on the received signaling, determining how or whether to offset the signal measurement. The method may then comprise, based on the signal measurement, as offset or not according to said determining, deciding whether or not to perform random access on the link. In one such embodiment, said determining is also based on at least one of any one or more of: a density of random access channel occasions on the link; a density of random access channel occasions configured for 2-step random access on the link; whether the link is configured with resources usable for both gapless message transmission and non-gapless message transmission; whether the link is configured for 4-step random access and/or 2-step random access; and whether the wireless device 24 is capable of gapless message transmission for random access. In one embodiment, the method further comprises receiving, from the radio network node 22, signaling indicating an offset to apply to a signal measurement performed on a link for which gapless message transmission 12 is configured.

In some embodiments, the link is a cell. In other embodiments, the link is a bandwidth part of a cell or a carrier. In any of the embodiments herein, the link may be deployed on an unlicensed frequency carrier.

In some embodiments, the method further comprises, based on the received signaling 26, performing random access on the link using gapless message transmission 12, including transmitting both a random access preamble 16 and a payload 18 based on the same clear channel assessment.

In some embodiments, the signaling 26 comprises broadcasted system information.

FIG. 4B shows a corresponding method performed by a radio network node 22. The method comprises transmitting, from the radio network node 22 to a wireless device 24, signaling 26 that indicates whether or not gapless message transmission 12 is configured for random access on a link (Block 450). According to gapless message transmission 12 a gap 20 in time, if any, between an end of a transmission of a random access preamble 16 and a start of a transmission of a payload 18 is less than or equal to a maximum gap threshold.

In some embodiments, the method further comprises transmitting, from the radio network node 22 to the wireless device 24, signaling indicating an offset that the wireless device 24 is to apply to a signal measurement performed on a link for which gapless message transmission 12 is configured.

In some embodiments, the link is a cell. In other embodiments, the link is a bandwidth part of a cell or a carrier. In any of the embodiments herein, the link may be deployed on an unlicensed frequency carrier.

In some embodiments, the signaling 26 comprises broadcasted system information.

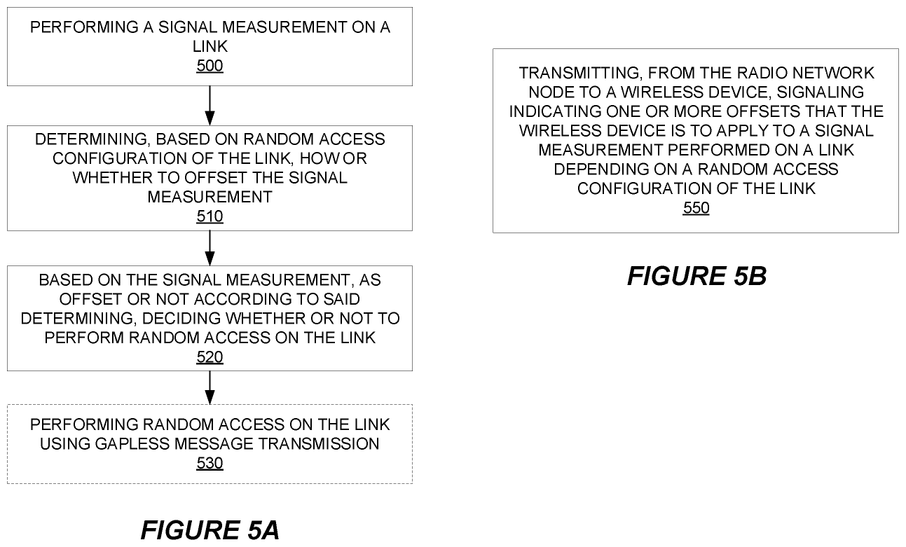

FIG. 5A shows a method performed by a wireless device according to other embodiments. As shown, the method comprises performing a signal measurement on a link (Block 500). The method also comprises determining, based on random access configuration of the link, how or whether to offset the signal measurement (Block 510). The method further comprises, based on the signal measurement, as offset or not according to said determining, deciding whether or not to perform random access on the link.

In some embodiments, the random access configuration includes whether or not gapless message transmission 12 is configured for random access on the link.

In some embodiments, the random access configuration includes at least one of any one or more of: a density of random access channel occasions on the link; a density of random access channel occasions configured for 2-step random access on the link; whether the link is configured with resources usable for both gapless message transmission and non-gapless message transmission; and whether the link is configured for 4-step random access and/or 2-step random access.

In some embodiments, the link is a cell. In other embodiments, the link is a bandwidth part of a cell or a carrier. In any of the embodiments herein, the link may be deployed on an unlicensed frequency carrier.

In some embodiments, the method further comprises receiving, from a radio network node, signaling indicating one or more offsets to apply to the signal measurement according to said determining.

In some embodiments, the method further comprises performing random access on the link using gapless message transmission 12, including transmitting both a random access preamble 16 and a payload 18 based on the same clear channel assessment.

FIG. 5B shows a corresponding method performed by a radio network node. The method comprises transmitting, from the radio network node to a wireless device, signaling indicating one or more offsets that the wireless device is to apply to a signal measurement performed on a link depending on a random access configuration of the link (Block 550).

In some embodiments, the random access configuration includes whether or not gapless message transmission 12 is configured for random access on the link.

In some embodiments, the random access configuration includes at least one of any one or more of: a density of random access channel occasions on the link; a density of random access channel occasions configured for 2-step random access on the link; whether the link is configured with resources usable for both gapless message transmission and non-gapless message transmission; and whether the link is configured for 4-step random access and/or 2-step random access.

In some embodiments, the link is a cell. In other embodiments, the link is a bandwidth part of a cell or a carrier. In any of the embodiments herein, the link may be deployed on an unlicensed frequency carrier.

Although not shown, a method performed by a wireless device in other embodiments herein may include receiving, from a radio network node, signaling indicating one or more offsets to apply to a signal measurement performed on a link depending on a random access configuration of the link. In some embodiments, the random access configuration includes whether or not gapless message transmission is configured for random access on the link. Alternatively or additionally, the random access configuration may include at least one of any one or more of: a density of random access channel occasions on the link; a density of random access channel occasions configured for 2-step random access on the link; whether the link is configured with resources usable for both gapless message transmission and non-gapless message transmission; and whether the link is configured for 4-step random access and/or 2-step random access.

In some embodiments, the link is a cell. In other embodiments, the link is a bandwidth part of a cell or a carrier. In any of the embodiments herein, the link may be deployed on an unlicensed frequency carrier.

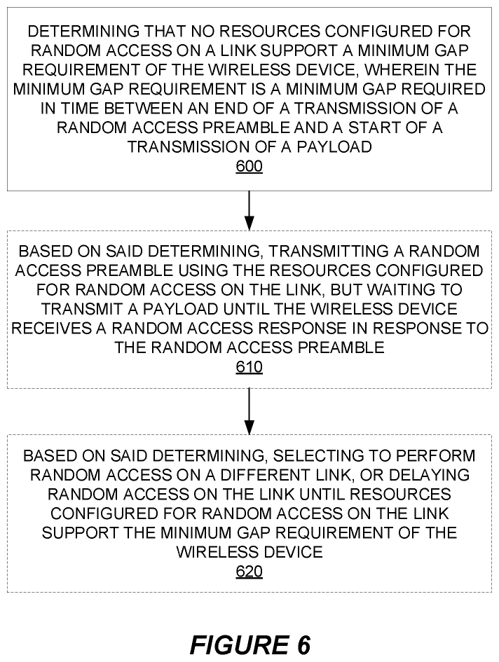

FIG. 6 shows a method performed by a wireless device 40 according to still other embodiments. The method comprises determining that no resources configured for random access on a link support a minimum gap requirement of the wireless device 40 (Block 600). This minimum gap requirement is a minimum gap required in time between an end of a transmission of a random access preamble 16 and a start of a transmission of a payload 18.

In some embodiments, the method further comprises, based on said determining, transmitting a random access preamble 16 using the resources configured for random access on the link, but waiting to transmit a payload 18 until the wireless device 40 receives a random access response in response to the random access preamble 16 (Block 610). Alternatively, the method further comprises, based on said determining, selecting to perform random access on a different link, or delaying random access on the link until resources configured for random access on the link support the minimum gap requirement of the wireless device 40 (Block 620).

In one or more embodiments, the transmitted random access preamble 16 is a 4-step random access preamble. In one such embodiment, the method further comprises selecting a random access preamble resource configured for a 2-step random access preamble, wherein said determining (Block 600) is performed after said selecting (Block 620).

In still other embodiments, the transmitted random access preamble 16 is a 2-step random access preamble. In one such embodiment, the random access response is a fallback random access response. Regardless, in some embodiments, the method further comprises selecting to perform a 4-step random access procedure for random access on the link, and after selecting to perform the 4-step random access procedure, determining that no resources are configured on the link for a 4-step random access procedure. The method in this case also comprises selecting to transmit a 2-step random access preamble based on said determining that no resources are configured on the link for a 4-step random access procedure, and after selecting to transmit a 2-step random access preamble, determining whether resources configured for random access on the link support the minimum gap requirement of the wireless device 40.

In one or more embodiments, the method further comprises selecting a random access preamble resource in which to transmit a random access preamble 16, irrespective of whether the random access preamble resource is configured for a 2-step random access preamble or a 4-step random access preamble. In one such embodiment, said determining (Block 600) is performed after selecting a random access preamble resource configured for a 2-step random access preamble.

In other embodiments, the method further comprises selecting a random access preamble resource configured for a 2-step random access preamble, and said determining (Block 600) is performed after said selecting.

In some embodiments, determining that no resources configured for random access on the link support the minimum gap requirement of the wireless device 40 comprises, for each combination of a random access preamble resource and a payload 18 resource configured for random access on the link, determining that a gap in time between an end of the random access preamble resource and a start of the payload resource is less than the minimum gap requirement of the wireless device.

In one or more embodiments, waiting to transmit a payload 18 until the wireless device 40 receives a random access response in response to the random access preamble 16 comprises discarding a payload prepared for transmission as part of a 2-step random access procedure.

In some embodiments, the link is a cell or a bandwidth part of a cell, and/or the link is deployed on an unlicensed frequency carrier.

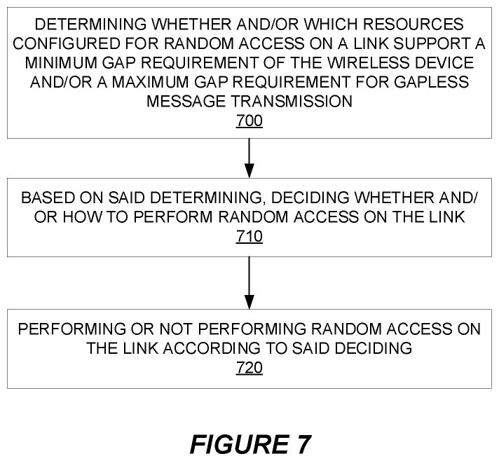

FIG. 7 illustrates a method performed by a wireless device 40 according to other embodiments. As shown, the method comprises determining whether and/or which resources configured for random access on a link support a minimum gap requirement of the wireless device 40 and/or a maximum gap requirement for gapless message transmission 12 (Block 700). Here, the minimum gap requirement is a minimum gap required in time between an end of a transmission of a random access preamble 16 and a start of a transmission of a payload 17. According to the maximum gap requirement, a gap in time, if any, between an end of a transmission of a random access preamble 16 and a start of a transmission of a payload 18 must be less than or equal to a maximum gap threshold.

The method as shown also comprises, based on said determining, deciding whether and/or how to perform random access on the link (Block 710). The method may then comprise performing or not performing random access on the link according to said deciding (Block 720).

In some embodiments, said deciding comprises selecting which resources to use for performing random access on the link. In this case, said performing comprises performing random access on the link using the selected resources.

In some embodiments, said deciding comprises selecting which random access preamble to use for performing random access on the link. In this case, said performing comprises transmitting the selected random access preamble.

In some embodiments, said deciding comprises deciding whether and/or how to use gapless message transmission 12 for random access on the link. In this case, said performing or not performing comprises using or not using gapless message transmission 12 for random access on the link according to said deciding.

In some embodiments, said deciding comprises deciding whether to use a 2-step procedure or a 4-step procedure for random access on the link. In this case, said performing or not performing comprises using the 2-step procedure or the 4-step procedure for random access on the link according to said deciding.

In some embodiments, the link is a cell or a bandwidth part of a cell, and/or the link is deployed on an unlicensed frequency carrier.

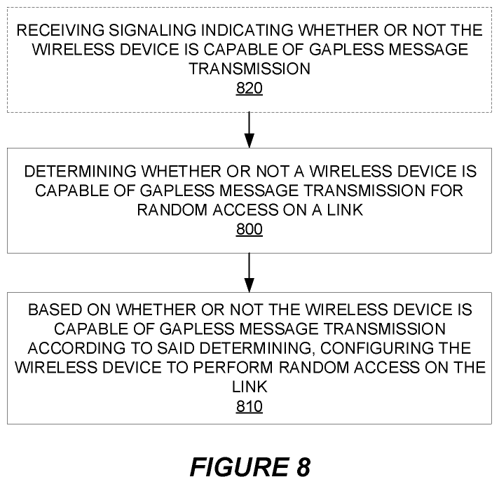

FIG. 8 illustrates a method performed by a radio network node 50 according to other embodiments herein. The method comprises determining whether or not a wireless device 40 is capable of gapless message transmission 12 for random access on a link (Block 800). Here, according to gapless message transmission 12, a gap in time, if any, between an end of a transmission of a random access preamble 16 and a start of a transmission of a payload 18 is less than or equal to a maximum gap threshold. The method also comprises, based on whether or not the wireless device 40 is capable of gapless message transmission 12 according to said determining, configuring the wireless device 40 to perform random access on the link (Block 810).

In some embodiments, the method further comprises receiving signaling indicating whether or not the wireless device is capable of gapless message transmission 12 (Block 820). In this case, said determining is based on the received signaling. In some embodiments, the signaling is received from the wireless device 40. In other embodiments, the signaling is received from another network node, e.g., in the case where the signaling comprises a handover request message or a secondary node addition request message.

In some embodiments, said determining comprises deducing whether or not the wireless device 40 is capable of gapless message transmission 12 based respectively on whether or not the wireless device 40 uses gapless message transmission 12 for random access on the link. In one embodiment, for example, said deducing comprises performing energy detection to determine whether or not the wireless device 40 transmits a payload using gapless message transmission 12 for random access on the link.

In some embodiments, said configuring comprises configuring the wireless device 40 with resources for gapless message transmission 12 or resources for non-gapless message transmission for random access on the link, depending respectively on whether or not the wireless device 40 supports or does not support gapless message transmission 12. Alternatively or additionally, said configuring comprises transmitting dedicated signaling to the wireless device 40 indicating said configuring of the wireless device 40. In one embodiment, for example, the dedicated signaling triggers the wireless device 40 to perform a mobility procedure, e.g., where the mobility procedure is a handover, a primary secondary cell group cell (PSCell) addition, a PSCell change, or a secondary cell (SCell) addition. In another embodiment, the dedicated signaling triggers the wireless device 40 to start monitoring a condition for execution of a conditional mobility procedure, e.g., where the conditional mobility procedure is a conditional handover, a conditional primary secondary cell group cell (PSCell) addition, a conditional PSCell change, or a conditional secondary cell (SCell) addition.

In some embodiments, said configuring comprises transmitting, via another radio network node, signaling to the wireless device 40 indicating said configuring of the wireless device 40.

Embodiments herein also include corresponding apparatuses. Embodiments herein for instance include a wireless device 10, 24, 40 configured to perform any of the steps of any of the embodiments described above for the wireless device 10, 24, 40.

Embodiments also include a wireless device 10, 24, 40 comprising processing circuitry and power supply circuitry. The processing circuitry is configured to perform any of the steps of any of the embodiments described above for the wireless device 10, 24, 40. The power supply circuitry is configured to supply power to the wireless device 10, 24, 40.

Embodiments further include a wireless device 10, 24, 40 comprising processing circuitry. The processing circuitry is configured to perform any of the steps of any of the embodiments described above for the wireless device 10, 24, 40. In some embodiments, the wireless device 10, 24, 40 further comprises communication circuitry.

Embodiments further include a wireless device 10, 24, 40 comprising processing circuitry and memory. The memory contains instructions executable by the processing circuitry whereby the wireless device 10, 24, 40 is configured to perform any of the steps of any of the embodiments described above for the wireless device 10, 24, 40.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 10, 24, 40. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node 14, 22, 50 configured to perform any of the steps of any of the embodiments described above for the radio network node 14, 22, 50.

Embodiments also include a radio network node 14, 22, 50 comprising processing circuitry and power supply circuitry. The processing circuitry is configured to perform any of the steps of any of the embodiments described above for the radio network node 14, 22, 50. The power supply circuitry is configured to supply power to the radio network node 14, 22, 50.

Embodiments further include a radio network node 14, 22, 50 comprising processing circuitry. The processing circuitry is configured to perform any of the steps of any of the embodiments described above for the radio network node 14, 22, 50. In some embodiments, the radio network node 14, 22, 50 further comprises communication circuitry.

Embodiments further include a radio network node 14, 22, 50 comprising processing circuitry and memory. The memory contains instructions executable by the processing circuitry whereby the radio network node 14, 22, 50 is configured to perform any of the steps of any of the embodiments described above for the radio network node 14, 22, 50.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

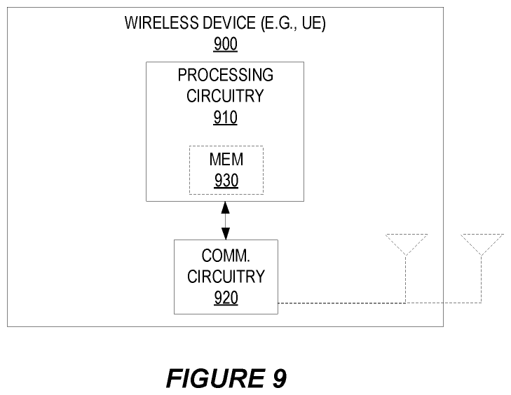

FIG. 9 for example illustrates a wireless device 900 (e.g., wireless device 10, 24, or 40) as implemented in accordance with one or more embodiments. As shown, the wireless device 900 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the wireless device 900. The processing circuitry 910 is configured to perform processing described above, such as by executing instructions stored in memory 930. The processing circuitry 910 in this regard may implement certain functional means, units, or modules.

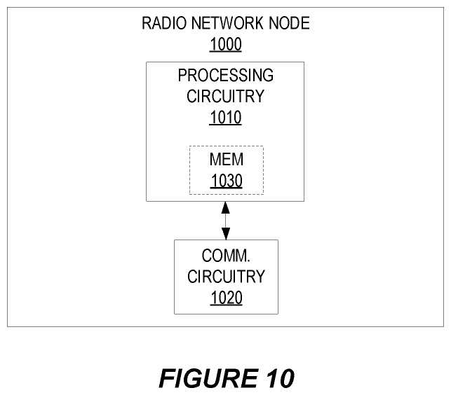

FIG. 10 illustrates a network node 1000 (e.g., radio network node 14, 22, or 50) as implemented in accordance with one or more embodiments. As shown, the network node 1000 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Some embodiments herein are applicable to New Radio (NR) over an unlicensed band. In this regard, next generation cellular systems are expected to support a wide range of use cases with varying requirements ranging from fully mobile devices to stationary Internet-of-Things (IoT) or fixed wireless broadband devices. The traffic pattern associated with many use cases is expected to consist of short or long bursts of data traffic with a varying length of waiting period in between (here called inactive state). In NR, both license assisted access and standalone operation in unlicensed spectrum (NR-U) (where unlicensed spectrum is also referred to as shared spectrum in this context) are to be supported in 3GPP.

With network operation in unlicensed spectrum follows a number of restrictions. One of them is that a device (e.g. a radio network node or a mobile terminal) has to monitor the shared medium, i.e. the channel, and determine that it is free (not being used by any other device) before starting to transmit on the channel. This procedure is referred to as Listen-Before-Talk (LBT) or Clear Channel Assessment (CCA).

In order to tackle the ever-increasing data demand, NR is considered for both licensed and unlicensed spectrum. NR-U needs to support dual connectivity (DC) and standalone scenarios, where the Medium Access Control (MAC) procedures including Random Access Channel (RACH) and scheduling procedure on unlicensed spectrum are subject to LBT and thus potential LBT failures. In Long Term Evolution (LTE) Licensed-Assisted Access (LAA), there are no such issues since the RACH and scheduling related signaling can be transmitted on the PCell in licensed spectrum instead of unlicensed spectrum.

In unlicensed spectrum, channel sensing should be applied to determine the channel availability before a physical signal is transmitted using the channel. This is the case, for example, for discovery reference signal (DRS) transmission such as the Primary Synchronization Signal (PSS)/Secondary Synchronization Signal (SSS), Physical Broadcast Channel (PBCH), Channel State Information Reference Signal (CSI-RS), control channel transmission such as Physical Uplink Control Channel (PUCCH)/Physical Downlink Control Channel (PDCCH), physical data channel such as Physical Uplink Shared Channel (PUSCH)/Physical Downlink Shared Channel (PDSCH), and uplink sounding reference signal such as Sounding Reference Signal (SRS) transmission.

The Radio Resource Management (RRM) procedures in NR-U would be generally rather similar to those in LAA, since NR-U is aiming to reuse LAA/eLAA/feLAA technologies as much as possible to handle the coexistence between NR-U and other legacy radio access technologies (RATs). Radio Resource Management (RRM) measurements and reporting comprise a special configuration procedure with respect to the channel sensing and channel availability.

In licensed spectrum, a user equipment (UE) measures Reference Signal Received Power (RSRP), and Reference Signal Received Quality (RSRQ) of the downlink radio channel, and provides the measurement reports to its serving eNB/gNB. However, they don't reflect the interference strength on the carrier. Another metric Received Signal Strength Indicator (RSSI) can serve for such purpose. At the eNB/gNB side, it is possible to derive RSSI based on the received RSRP and RSRQ reports. However, this requires that they must be available. Due to the LBT failure, some reports in terms of RSRP or RSRP may be blocked, e.g., either due to that the reference signal transmission (DRS) is blocked in the downlink or the measurement report is blocked in the uplink. Hence, the measurements in terms of RSSI are very useful. The RSSI measurements together with the time information concerning when and how long of time UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy) for measurement reports. The channel occupancy is defined as the percentage of time that RSSI was measured above a configured threshold. For this purpose, a RSSI measurement timing configuration (RMTC) includes a measurement duration (e.g. 1-5 ms) and a period between measurements (e.g. {40, 80, 160, 320, 640} ms).

Hence, channel access/selection for LAA was one of the important aspects for co-existence with other RATs such as Wi-Fi. For instance, LAA has aimed to use carriers that are congested with Wi-Fi.

Some embodiments more particularly apply to the context of channel access procedure in NR-U. In this regard, Listen-before-talk (LBT) is designed for unlicensed spectrum co-existence with other RATs. In this mechanism, a radio device applies a clear channel assessment (CCA) check (i.e. channel sensing) before any transmission. The transmitter involves energy detection (ED) over a time period compared to a certain energy detection threshold (ED threshold) in order to determine if a channel is idle. In case the channel is determined to be occupied, the transmitter performs a random back-off within a contention window before next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, four LBT priority classes are defined for differentiation of channel access priorities between services using different contention window sizes (CWS) and MCOT durations.

As described in 3GPP TR 38.889 v16.0.0, the channel access schemes for NR-based access for unlicensed spectrum can be classified into the following categories.

Cat-1: Immediate transmission after a short switching gap. This is used for a transmitter to immediately transmit after an uplink/downlink switching gap inside a COT. The switching gap from reception to transmission is to accommodate the transceiver turnaround time and is no longer than 16 μs.

Cat-2: LBT without random back-off. The duration of time that the channel is sensed to be idle before the transmitting entity transmits is deterministic.

Cat-3: LBT with random back-off with a contention window of fixed size. The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Cat-4: LBT with random back-off with a contention window of variable size. The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

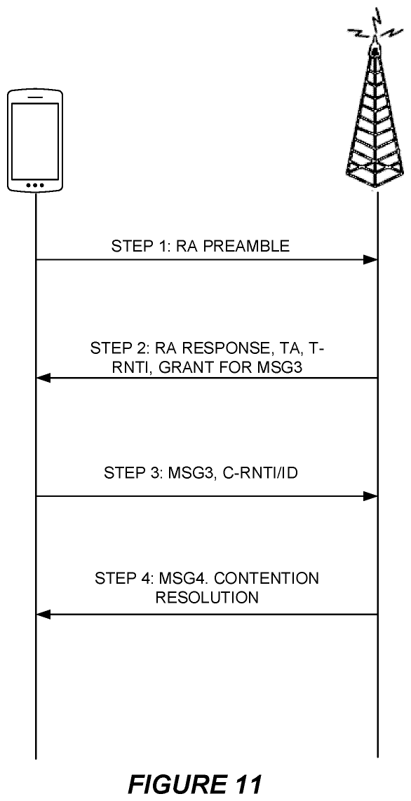

4-step random access herein may refer to the following, e.g., as exemplified in the context of NR in FIG. 11.

Step 1: Preamble Transmission

The UE randomly selects a random access (RA) preamble (PREAMBLE_INDEX) corresponding to a selected SS/PBCH block, and transmits the preamble on the PRACH occasion mapped by the selected SS/PBCH block. When the gNB detects the preamble, it estimates the Timing alignment (TA) the UE should use in order to obtain UL synchronization at the gNB.

Step 2: RA Response (RAR)

The gNB sends a RA response (RAR) including the TA, the Temporary Cell Radio Network Temporary Identifier (TC-RNTI) (temporary identifier) to be used by the UE, a Random Access Preamble identifier that matches the transmitted PREAMBLE_INDEX and a grant for Msg3. The UE expects the RAR and thus, monitors the PDCCH addressed to Random Access Radio Network Temporary Identifier (RA-RNTI) to receive the RAR message from the gNB until the configured RAR window (ra-ResponseWindow) has expired or until the RAR has been successfully received.

From 38.321 v16.0.0: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

Step 3: “Msg3” (UE ID or UE-specific C-RNTI)

In Msg3 the UE transmits its identifier (UE ID) for initial access or if it is already in RRC_CONNECTED or RRC_INACTIVE mode and needs to e.g. resync, its UE-specific RNTI. If the gNB cannot decode Msg3 at the granted UL resources, it may send a Downlink Control Information (DCI) addressed to TC-RNTI for retransmission of Msg3. Hybrid Automatic Repeat Request (HARQ) retransmission is requested until the UEs restart the random access procedure from step 1 after reaching the maximum number of HARQ retransmissions or until Msg3 can be successfully received by the gNB.

Step 4: “Msg4” (Contention Resolution)

In Msg4 the gNB responds by acknowledging the UE ID or Cell Radio Network Temporary Identifier (C-RNTI). The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

In LTE, the 4-step RA cannot be completed in less than 14 ms/Transmission Time Interval/Subframe.

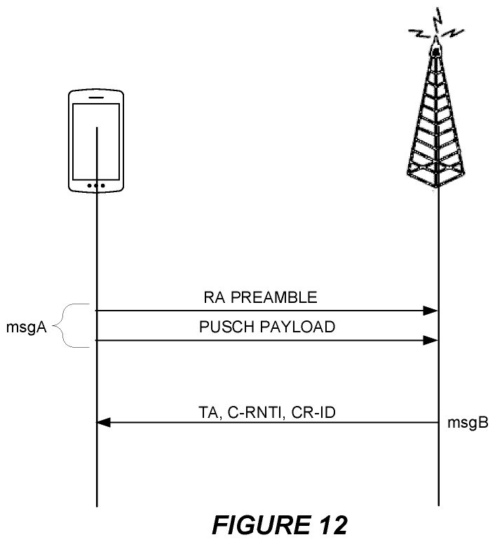

Other embodiments herein exploit a 2-step random access procedure. The 2-step RA gives much shorter latency than the ordinary 4-step RA. In the 2-step RA the preamble and a message corresponding to Msg3 (msgA PUSCH) in the 4-step RA can, depending on configuration, be transmitted in two subsequent slots. The msgA PUSCH is sent on a resource dedicated to the specific preamble. This means that both the preamble and the Msg3 face contention but contention resolution in this case means that either both preamble and Msg 3 are sent without collision or both collide. The 2-step RA procedure is depicted in FIG. 12.

Upon successful reception msgA, the gNB will respond with a msgB. The msgB may be either a “successRAR”, “fallbackRAR or “Back off”. The content of msgB has been agreed as seen below. We note in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility to replace the 4-step message exchange by a 2-step message exchange would lead to reduced RA latency and that fewer LBTs (in case of unlicensed) needing to be executed. On the other hand, the 2-step RA will consume more resources since it uses contention-based transmission of the data. This means that the resources that are configured for the data transmission may often be unused.

If both the 4-step and 2-step RA are configured in a cell on shared PRACH resources (and for the UE), the UE will choose its preamble from one specific set if it wants to do a 4-step RA, and from another set if it wants to do a 2-step RA. Hence a preamble partition is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or 4-step procedure.

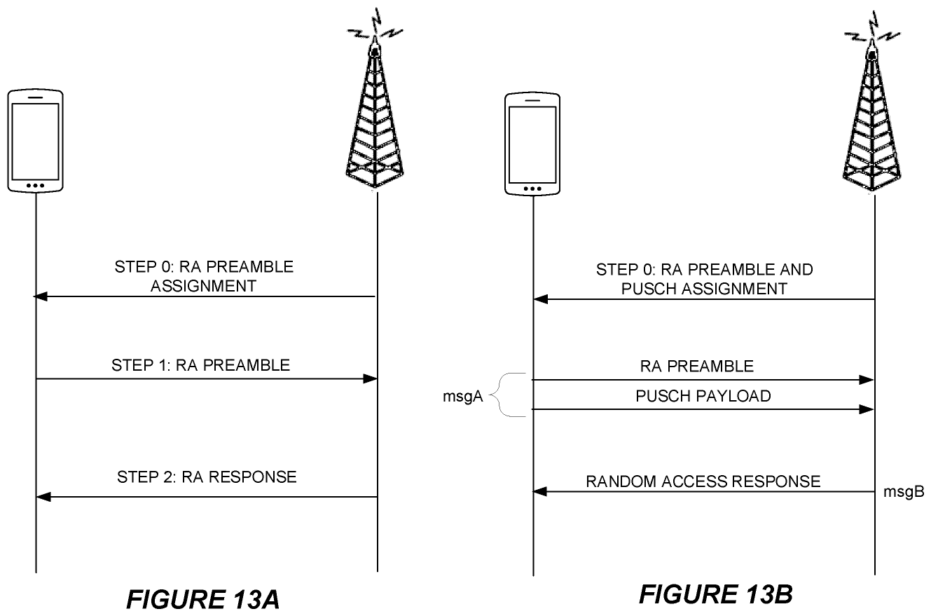

Contention-Free Random Access (CFRA) procedures for 4-step and 2-step random access are illustrated in FIGS. 13A and 13B, respectively. The network assigns a preamble for CFRA in 4-step RACH or a preamble and PUSCH for CFRA in 2-step RACH, and it does not configure CFRA resources for 4-step and 2-step RA types at the same time for a Bandwidth Part (BWP). And CFRA with 2-step RA type is only supported for handover.

The Msg1 of 4-step includes only a preamble on PRACH, while the MSGA of the 2-step RA type includes a preamble on PRACH and a payload on PUSCH. After Msg1 transmission or MSGA transmission, UE monitors for a response from the network within a configured window. For CFRA, upon receiving the network response, the UE ends the random access procedure.

In some embodiments, for msgA retransmission (i.e. preamble and PUSCH) it is assumed that the UE retries on 2-step RACH. In one embodiment, the UE can fallback to 4-step RACH after a certain time. The network response to msgA (i.e. msgB/msg2) can include the following: SuccessRAR, FallbackRAR, or Backoff Indication. The FallbackRAR may contain the following fields: RAPID, UL grant (to retransmit the msgA payload), TC-RNTI, and TA command.

The following fields can be included in the successRAR when CCCH message is included in msgA: Contention resolution ID; C-RNTI; and TA command.

Upon receiving the fallbackRAR, the UE shall proceed to msg3 step of 4-step RACH procedure.

In some embodiments, RA type selection is performed before beam selection. There is no need to reexecute RA selection criteria upon fallback failure (i.e if reception of msg3 fails). The UE re-transmits using msgA. If the random access procedure is not successfully completed even after transmitting the msgA ‘N’ times, UE fallbacks to 4 step RACH procedure i.e. UE only transmits the PRACH preamble. The network can configure the number of times ‘N’, a UE can attempt to re-transmit msgA during the random access procedure.

For NR-U, the UE will have to do a LBT before transmitting the preamble in the selected PRACH occasion (RO). In case there is no gap (or if the gap is less than 16 μs) between the RO and the PUSCH occasion (PO) where the msgA PUSCH is transmitted (i.e. between the end of the PRACH preamble transmission and the start of the PUSCH transmission), the msgA PUSCH is transmitted without doing a new LBT. This is referred to herein as msgA gapless transmission, i.e., there is either no gap or the gap is less than 16 us. However, in case there is a gap (longer than 16 μs) between the RO and the PO where the msgA PUSCH is transmitted the UE is forced to do a new LBT before transmitting msgA PUSCH. This is referred to herein as non-gapless msgA transmission. Doing a new LBT will increase the probability that the msgA transmission fail due to unsuccessful LBT.

For licensed access, the minimum transmission gap between the end of msgA PRACH and the beginning of msgA PUSCH (guard time excluded) is no less than Ngap symbols, as specified in TS 38.213, i.e., 2 or 4 symbols depending on the SCS (subcarrier spacing). This minimum gap is not applied for NR-U.

Some embodiments herein address an issue that may occur in NR-U systems; namely, that the msgA transmission fails due to LBT. In case the preamble fails LBT, there will be no PUSCH transmission and the UE will retry msgA transmission when the msgB window expires. In case the preamble has a successful LBT and is transmitted but the PUSCH fails LBT (i.e. there is a gap between PRACH and msgA PUSCH exceeding 16 μs), the gNB has the option to respond with a fallbackRAR containing a grant for msgA PUSCH (PUSCH) transmission. If this is not received by the UE, it will retry msgA transmission when the msgB window expires.

In many configurations, there will be several consecutive PRACH occasions (ROs) within a PRACH slot. The UE will heretofore randomly select one of these ROs for its preamble transmission. In particular, the UE heretofore determines the next available PRACH occasion from the PRACH occasions corresponding to the selected Synchronization Signal Block (SSB) (the MAC entity shall heretofore select a PRACH occasion randomly with equal probability among the consecutive PRACH occasions allocated for 2-step random access according to subclause 8.1 of TS 38.213 v16.0.0, corresponding to the selected SSB; the MAC entity may take into account the possible occurrence of measurement gaps when determining the next available PRACH occasion corresponding to the selected SSB.

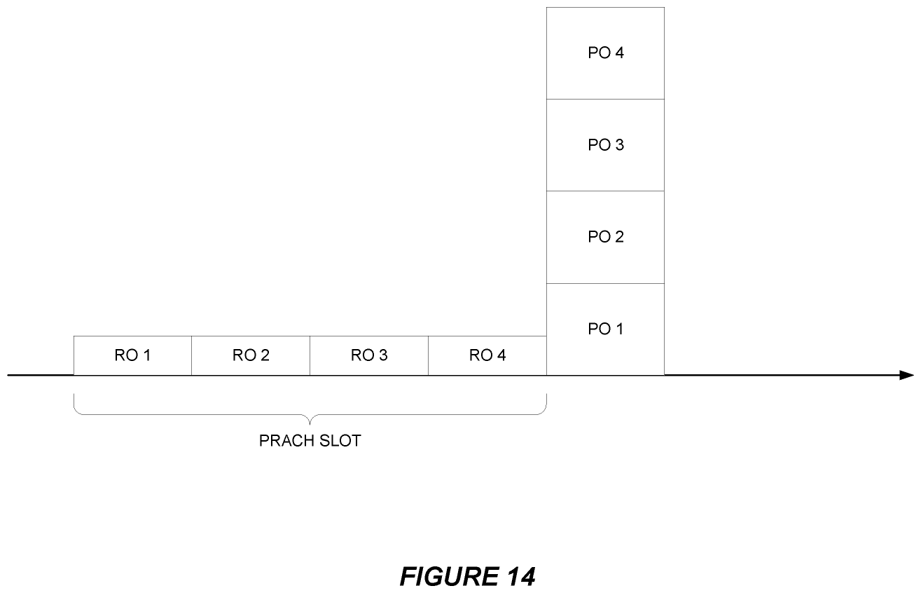

A high level example illustrating a configuration of this type is shown in FIG. 14. Shown is a 2-step configuration with 4 consecutive ROs in a PRACH slot with 4 associated frequency-multiplexed (FDMed) POs. 4 ROs are configured in the PRACH slot for a certain SSB. In this example, these 4 ROs are mapped to 4 PUSCH occasions (POs), e.g. a preamble transmission in RO 1 will have its PUSCH transmission in PO 1, etc.

The UE will have to do a LBT before transmitting the preamble in the selected RO. In case the selected RO is RO 4 there is no gap (or at least the gap is smaller than 16 μs) between the RO and the PO where the msgA PUSCH is transmitted. In this case, the UE does not do a new LBT when transmitting msgA PUSCH. However, in case the selected RO is e.g. RO 1, there is a gap (longer than 16 μs) between the RO and the PO where the msgA PUSCH is transmitted. In this case, the UE is forced to do a new LBT when transmitting msgA PUSCH. Doing a new LBT will increase the probability that the msgA transmission fails due to unsuccessful LBT.

Consider now /.,mnbvbnm,./additional details regarding MsgA configurations and MsgA preamble to MsgA PUSCH mapping according to some embodiments.

A RACH occasion is the time frequency resource used for a preamble transmission. In some embodiments, the RACH occasions for 2-step RACH can be either separately configured (also known as Type-2 random access procedure with separate configuration of PRACH occasions with Type-1 random access procedure) or shared with 4-step RACH (also known as Type-2 random access procedure with common configuration of PRACH occasions with Type-1 random access procedure) in which case different set of preamble IDs will be used.

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by MsgA-CB-PreamblesPerSSB. The PRACH transmission can be on a subset of PRACH occasions associated with a same SS/PBCH block index for a UE provided with a PRACH mask index by MsgA-ssb-sharedRO-Masklndex.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-MsgA when provided; otherwise, by ssb-perRACH-OccasionAndCB-PreamblesPerSSB.

A PUSCH occasion (PO) is defined as the time frequency resource used for one PUSCH transmission. For one MsgA PUSCH occasion, one or more Demodulation Reference Signal (DMRS) resources can be configured, one of which will be selected for each PUSCH transmission with in the PUSCH occasion. The term PUSCH resource unit (PRU) is used herein to define a PUSCH occasion with one DMRS resource.

A set of PUSCH occasions is configured per MsgA PUSCH configuration which are relative to and mapped by a group of preambles in a set of ROs in one PRACH slot. A mapping between one or multiple PRACH preambles and a PUSCH occasion associated with a DMRS resource is according to the mapping order as described below. The design may consider factors such as resource utilization efficiency and decoding complexity at gNB. For different RA events and different purposes, the payload size of a MsgA may vary in a range from a few bytes to a few hundred bytes. For better spectral efficiency, different mapping rules between preambles in each RO and associated PUSCH resource unit are expected such as: One-to-One Mapping or Many-to-One Mapping.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index [4, TS 38.211]
third, in increasing order of time resource indexes t_{id} for time multiplexed PUSCH occasions within a PUSCH slot
fourth, in increasing order of indexes for NS PUSCH slots

where N_{preamble}=ceil(T_{preamble}/T_{PUSCH}), T_{preamble} is a total number of valid PRACH occasions per association pattern period multiplied by the number of preambles per valid PRACH occasion provided by MsgA-PUSCH-PreambleGroup, and T_{PUSCH} is a total number of valid PUSCH occasions per PUSCH configuration per association pattern period multiplied by the number of DMRS resource indexes per valid PUSCH occasion provided by MsgA-DMRS-Config.

Some embodiments herein address challenges in this context. In particular, in NR-U scenarios, for a 2-step RA based transmission, transmission of msgA using at most one LBT is beneficial, especially in cases when channel occupancy is high. Using a single LBT prior to transmission of a MsgA means that the gap between the preamble and the payload (i.e. MsgA PUSCH) needs to be sufficiently short, i.e. less than 16 μs. This case is referred to as gap-less MsgA transmission (i.e. gap-less MsgA transmission refers to cases where the gap between the PRACH transmission (i.e. the RO) and the MsgA PUSCH transmission (i.e. the PO/PRU) is in the range 0 μs≤gap<16 μs). A corresponding UE capability indicating that a UE supports gap-less MsgA may be introduced for NR-U in NR Rel-16. The reason for the capability indication is that some low end UEs might not support gap-less MsgA transmission, because of the large power level difference between the PRACH and PUSCH.

In most cases, a UE provides its capability information to a gNB during its initial access procedure. This means that, heretofore, the gNB would not be aware of the UE's gap-less MsgA capability prior to reception of a 2-step RA transmission initiated by the UE for initial access.

A problematic case then is if a cell is configured for gap-less msgA transmission and the UE does not support this. Heretofore, this could result in situations where the UE selects PRACH and PUSCH resources where the UE cannot transmit msgA, or at least not the msgA PUSCH. There could also be configurations where some RO-PO combinations require gap-less transmission capability while other RO/PO combinations do not.

For the above aspects, there are two issues observed. Issue 1: signaling means are needed for the gNB to inform UEs on whether the cell supports gap-less MsgA. Also needed are cell selection and re-selection procedures in relation to different combinations of UE gapless MsgA transmission capability and MsgA resource configurations (with or without gap). Issue 2: UE behavior needs to be specified for UEs not supporting gap-less transmission in cells where gap-less msgA transmission is configured.

Some embodiments herein include corresponding solutions to address the above issues.

In licensed frequency bands, the MsgA gap requirement for a UE between the MsgA preamble and MsgA PUSCH is defined as below. In the procedures defined in section 8.1A of 3GPP TS 38.213 V16.0.0, it's also possible that the gap between preamble and a PO does not meet the requirement. If a UE capability is defined to support both transmission with a gap and without a gap, then it is not a network misconfiguration if the network configures a PO closer to a preamble than the gap requirement.

For operation without shared spectrum channel access, the PUSCH transmission is after the PRACH transmission by at least N symbols where N=2 for p=0 or p=1, N=4 for p=2 or p=3, and p is the subcarrier spacing (SCS) configuration for the active uplink bandwidth part (BWP).

Furthermore, when the UE capability is known, e.g. in the case of CFRA, the network may also need to configure the MsgA resources or determine an RA type taking into account of the minimum gap size between MsgA preamble and MsgA PUSCH that the UE supports. In addition, the RA type supported should also be considered. Related methods are also provided herein.

For example, a first embodiment herein includes a method in a UE of selecting a cell to access and random access resources to use on the cell, comprising one or more of: (a) Receiving signaling indicating that the cell supports transmission by a UE of a first PUSCH that follows a PRACH by a delay less than a predetermined value; (b) If the UE supports transmission of a PUSCH that follows a PRACH by a delay less than the predetermined value, transmitting the PRACH and first PUSCH with a delay less than the predetermined value on resources used by the cell; and (c) If the UE does not support transmission of a PUSCH that follows a PRACH by a delay less than the predetermined value, performing at least one of: determining to not access the cell, transmitting the PRACH and first PUSCH with a delay not less than the predetermined value on resources used by the cell, or transmitting the PRACH but not the first PUSCH on resources used for the cell.

In one example of the first embodiment, transmitting the PRACH but not the first PUSCH on resources used for the cell further comprises: Receiving a random access response addressed to the PRACH; and Transmitting a second PUSCH in resources identified by the random access response. For example, transmitting the PRACH may comprise transmitting a 4-step RA preamble, i.e. a preamble designated for 4-step RA. In another example, transmitting the PRACH comprises transmitting a 2-step RA preamble, i.e. a preamble designated for 2-step RA.

Alternatively or additionally, resources in the first embodiment may be further identified as available within a bandwidth part of the cell.

The first embodiment may enable a UE that does not support gap-less RACH-PO to use cells or resources that have an RO-PO gap.

A second embodiment herein includes a method for a random access procedure for shared spectrum access in a UE, comprising one or more of: (i) Receiving a first and a second configuration identifying a random access preamble occasion (‘RO’) and a PUSCH transmission occasion (‘PO’), respectively; (ii) Determining a delay between the end of a random access preamble transmission in the RO and the start of the PO from the first and second configurations; (iii) When the delay is not more than a first predetermined value, transmitting a random access preamble in its RO, wherein the UE is identified as supporting transmission of the random access preamble followed by a PUSCH at a delay not more than the predetermined value; (iv) When the delay is not less than a second value, determining if a slot is idle and transmitting the PUSCH it its PO if the slot is idle; and (v) when the delay is less than the second value, transmitting the PUSCH it its PO.

The second embodiment may enable a ‘gapless’ NR-U UE to select a PO according to its low RO-PO delay capability and perform LBT ensuring that the RO-PO delay meets the requirements of the LBT category the UE uses).

A third embodiment includes a method for a random access procedure in a UE, comprising one or more of: (i) Receiving a first and a second configuration identifying a random access preamble occasion (‘RO’) and a PUSCH transmission occasion (‘PO’), respectively; (ii) Determining a delay between the end of a random access preamble transmission in the RO and the start of the PO from the first and second configurations; (iii) When the delay is not more than a first predetermined value, transmitting a random access preamble in its RO and a PUSCH in its PO; and (iv) when the delay is more than the first predetermined value, transmitting a second random access preamble not associated with a PUSCH.

The third embodiment may for example enable a UE to select a PO with large enough RO-PO delay and otherwise transmit a 4-step preamble.

A sixth embodiment includes a method for a random access procedure in a UE, comprising one or more of: (i) Receiving a first and a second configuration identifying a random access preamble occasion (‘RO’) and a PUSCH transmission occasion (‘PO’), respectively; (ii) Determining a delay between the end of a random access preamble transmission in the RO and the start of the PO from the first and second configurations; (iii) When the delay is not more than a first predetermined value, transmitting a random access preamble in its RO and a PUSCH in its PO; and (iv) When the delay is more than the first predetermined value, transmitting the random access preamble.

The sixth embodiment may enable a UE to select a PO with large enough RO-PO delay and otherwise transmit the 2-step preamble.

Some further UE aspects include e.g.: the UE may apply an offset to a cell in the cell (re)selection procedure in order to favor a cell with certain RA configurations, e.g. support for gapless MsgA transmission or support for non-gapless MsgA transmission, depending on the UE's RA capabilities, in particular whether the UE supports or does not support gapless MsgA transmission.

A seventh embodiment herein includes a method in a first network node for supporting random access in a cell, comprising: (i) acquiring information related to a UE's capability to support or not support gapless MsgA transmission; and (ii) configuring the UE for random access based on the acquired information.

In one example of the seventh embodiment, the step of acquiring comprises receiving the information in a signaling message from the UE.

In another example of the seventh embodiment, the step of acquiring comprises receiving a MsgA from the UE and determining that the MsgA transmission was gapless. The method may further comprise determining that the UE is capable of gapless MsgA transmission.

In yet another example of the seventh embodiment, the step of acquiring comprises receiving a MsgA from the UE and determining that the MsgA transmission comprised a gap (longer than 16 μs), determining that the cell provides both gapless and non-gapless RO-PO combinations and concluding that the UE does not support gapless MsgA transmission.

In still another example of the seventh embodiment, the step of acquiring comprises receiving the information in a message from another network node. [Note: A handover case where the UE's capability is indicated in the XnAP Handover Request message.] In one such embodiment, the message is an XnAP Handover Request message or an XnAP S-Node Addition Request message.

In another example of the seventh embodiment, the configuring step further comprises: (i) configuring the UE with gapless MsgA transmission resources (i.e. RO-PO combinations with a gap smaller than 16 μs between the RO and the PO), if the acquired information indicates that the UE supports gapless MsgA transmission, or (ii) configuring the UE with non-gapless MsgA transmission resources (i.e. RO-PO combinations with a gap larger than 16 μs between the RO and the PO), if the acquired information indicates that the UE does not support gapless MsgA transmission. In one such case, the MsgA transmission resource configuration is sent to the UE in a dedicated RRC message, e.g., the dedicated RRC message triggers the UE to perform a mobility procedure involving a target cell controlled by a second gNB. The mobility procedure may be one of a handover, a PSCell addition, a PSCell change, or a SCell addition. Alternatively or additionally, the dedicated RRC message may trigger the UE to start monitoring a condition for execution of a conditional mobility procedure, e.g., the conditional mobility procedure is one of a conditional handover, a conditional PSCell addition, a conditional PSCell change, or a conditional SCell addition.

In one example of the seventh embodiment, the configuring comprises transmitting the configuration to the UE via a second network node. [Note: The first network node is a target node or candidate target node which provides the RA configuration for the UE to apply in the target cell.]

In another example of the seventh embodiment, the configuring comprises receiving the configuration in a message from a second network node. [Note: The first network node is a source node which receives the RA configuration—as a part of more extensive radio resource configuration—from a target node or a candidate target node, for forwarding to the UE.] In one such example, the message is an XnAP Handover Request Acknowledge message or an XnAP S-Node Addition Request Acknowledge message.

Some further network node (gNB) aspects include e.g.:
The network node may indicate to a UE whether it supports gapless MsgA transmission.
The network node may support different RA configuration variants for a cell, wherein not all configuration variants include gapless MsgA transmission resources and wherein the network node may choose to activate or deactivate the configuration of gapless MsgA transmission resources based on various conditions, including e.g. the load in the cell or on processing resources associated with the cell, the QoS required by served UEs, the channel occupancy.
The network node may provide one or more offset(s) to apply in the cell (re)selection procedure depending on the combination of the UE's gapless MsgA transmission capability (support or no support) and the RA configuration (in particular the 2-step RA configuration and the presence of absence of gapless MsgA transmission resources).

Certain embodiments may provide one or more of the following technical advantage(s). With the proposed mechanisms, the UE's behavior in situations where its gapless MsgA capability does not perfectly match the network's MsgA configurations becomes well defined and ensures smooth and efficient operation in all cases. Alternatively or additionally, the random access performance will be enhanced and/or the QoS of the associated services are enhanced.

More particularly, the network may or may not be able to support gap-less MsgA transmission and may or may not configure MsgA resources with RO/PO combinations with a gap smaller than 16 μs between the RO and the PO. According to some embodiments herein, in cases where the network does not support, or does not configure, gap-less transmission, it may indicate so via common or dedicated signaling to the UE. However, network capability may not be indicated or may be indicated explicitly. Therefore, alternatives for configuring gap-less operation on a cell are to configure UEs in the cell to access the cell using gap-less transmission, or to configure the ROs and POs on the cell such that at least some of the RO/PO combinations are gap-less. Therefore as used herein, unless stated otherwise, cases where a network supports gap-less transmission can be identified as when the network signals this directly, when it configures the UE to access the cell using gap-less MsgA transmission, or when it configures random access resources such that gap-less MsgA transmission is possible (or required) on the cell.

Configuration and Signaling Aspects

In a first embodiment, a gNB can signal whether the cell is supporting gap-less MsgA transmission in system information (in the MIB or in one of the SIBs, e.g. SIB1). A new field may be introduced accordingly. Alternatively, the signaling is carried using Reserved fields or reusing existing fields.

A gNB may also signal whether the cell supports gapless MsgA transmission through the 2-step RA configuration, in particular the RO and PO configuration, wherein the UE can derive the length of the RO-PO-gap based on the delay/gap between the configured RO-PO combinations.

The gNB may indicate any of:
The cell has 2-step RA configuration supporting only gapless MsgA transmission.
The cell has 2-step RA configuration supporting both gapless MsgA transmission and MsgA transmission with gap.
The cell has 2-step RA configuration supporting only MsgA transmission with gap.

In a second embodiment, a cell is configured with gap-less MsgA transmission feature. The cell enables or disables the features based on conditions such as:
1) The cell load. Supporting gap-less MsgA transmission would add extra processing load to the gNB. Therefore, the gNB may decide to enable the feature only in case of low load. When the cell load is above a configured threshold, the gNB can disable the feature. Here, the load may be nuanced and divided into different kinds of load, affecting different parts or different functions or functional entities of a gNB. In this case, the load on the processing resources handling random access, and in particular 2-step random access, may be what determines whether the gNB activates the gapless MsgA transmission feature.
2) Whether or not there are served UEs, e.g. UEs in RRC_CONNECTED state, employing services with critical QoS requirements such as critical latency requirements which would be beneficial to apply gap-less MsgA transmission.
3) The current (or recently measured) channel occupancy (or a recent average of channel occupancy measurements, e.g. a weighted average or an exponential average), in case the gNB operates the cell in unlicensed spectrum.

Whenever the gNB enables or disables the feature, the gNB sends signaling to relevant UEs via signaling transmitted in a broadcast/group cast fashion or dedicated signaling transmitted to dedicated UEs. The signaling may be carried via system information, dedicated Radio Resource Control (RRC) signaling, Medium Access Control (MAC) Control Element (CE) or Downlink Control Information (DCI).

In an alternative, the network (NW) can use BWP switching type of signalling for controlling the use of Serving Cell(s) supporting gap-less MsgA transmission. By activating an inactive BWP and/or deactivate an active BWP at a time, this BWP signalling can facilitate the use of a set of configured gap-less supported BWPs, e.g. at RA procedure initialization. This could be controlled by PDCCH indicating a downlink assignment, an uplink grant or using a MAC CE signalling or other based on UE capability. As another alternative, activation and deactivation of secondary cells (SCells) may be used in a similar way.

In a third embodiment, a cell may be configured with both gap-less MsgA transmission and non-gap-less MsgA transmission. There may be several options to configure the cell.

Option 1: the cell is configured with multiple MsgA PUSCH configurations or MsgA transmission configurations. Wherein, at least one configuration is associated with a gap-less MsgA transmission based 2-step RA, while at least another configuration is associated with a non-gap-less MsgA transmission based 2-step RA.

Option 2: the cell is configured with at least one MsgA PUSCH configuration or MsgA transmission configurations which contains both gap-less POs and non-gap-less POs. In the configuration, one or multiple preambles in each RO may be mapped to at least one gap-less PO and at least one non gap-less PO. Alternatively, there are only preambles in specific ROs are mapped to at least one gap-less PO and at least one non gap-less PO, while preambles in other ROs are mapped to only one PO (either gap-less or non gap-less).

In an alternative embodiment, or as an addition to the above, for where the cell frequency has been partitioned into Bandwidth Parts, BWP; in which case these UEs are assigned/configured BWPs for where only some are configured with support of gap-less MsgA transmission BWP(s).

In some embodiments, a gNB may acquire information about the UE's gapless MsgA transmission capability, e.g. if the UE supports or does not support gapless MsgA transmission. The gNB may acquire this information in different ways, including:
Explicit signaling from the UE, e.g. RRC signaling of UE capability information.
If the gNB receives a gapless MsgA transmission, the gNB may determine that the UE supports gapless MsgA transmission.
If the gNB receives a non-gapless MsgA transmission from a UE in a cell where support for gapless MsgA transmission is provided, the gNB may infer that the UE (probably) does not support gapless MsgA transmission.
A gNB may receive the information from another gNB. This may occur when the gNB is a target gNB of a mobility procedure, or a candidate target gNB of a conditional mobility procedure, and receives the information during the preparation phase of a (conditional) mobility procedure, e.g. in an XnAP Handover Request message in case of a handover or an XnAP S-Node Addition Request message. Other mobility procedures in this context include PSCell addition, PSCell change and SCell addition.

A gNB may configure a UE with RA configuration, in particular 2-step RA configuration and gapless or non-gapless MsgA transmission recourses based on information about the UE's RA capabilities, in particular whether the UE supports gapless MsgA transmission. This may occur e.g. in conjunction with a mobility procedure (or a conditional mobility procedure) where the target gNB (or (candidate target gNB) provides a configuration for the UE to apply when accessing the target cell. This configuration is then sent to the source gNB in an XnAP message, such as the XnAP Handover Request Acknowledge message or the XnAP S-Node Addition Request Acknowledge message, after which the source gNB forwards the configuration to the UE in an RRC message.

UE Aspects

In a first embodiment, for a UE configured with the capability to support gap-less MsgA transmission, during cell selection and reselection procedure, the UE selects a suitable cell to camp on not only considering the ordinary measurements in terms of downlink (DL) radio quality, but also considering if the cell supports (i.e. has configured) gap-less MsgA transmission. The UE selects the cell providing strongest DL radio connection (e.g., in terms of RSRP or RSRQ) and supporting gap-less MsgA transmission. If there is not any cell supporting gap-less MsgA transmission, the UE may select the cell providing strongest DL radio connection (e.g., in terms of RSRP or RSRQ) and supporting 2-step RA. When selecting a cell not supporting gap-less transmission but still transmitting using 2-step RACH, the UE may only transmit on POs that have a large enough gap between the PO and the preamble that the UE transmits. A benefit of selecting a cell based on whether gap-less transmission is supported is that the UE may have minimal latency in 2-step RACH transmission, presuming that cells with sufficiently good radio link quality for the UE are available. If there is not any cell supporting 2-step RA, the UE may select the cell providing strongest DL radio connection (e.g., in terms of RSRP or RSRQ).

In an alternative embodiment, the UE may not employ a “layered” cell (re)selection procedure (such as considering a cell's support or no support for gapless MsgA transmission as a first condition and then considering the channel quality (e.g. RSRP or RSRQ) among the cells fulfilling the first condition), but rather a employs a cell (re)selection procedure which considers both these aspects in a combined, integrated or weighted manner. To this end, a UE supporting gapless MsgA transmission may for instance apply an offset to the measured channel quality of a cell depending on its support or no support for gapless MsgA transmission, such that e.g. a first cell that supports gapless MsgA transmission is favored over a second cell which does not support gapless MsgA transmission, even if the second cell has a similar channel quality as the first cell, or even slightly better (but less than the offset) channel quality than the first cell. Similarly, a UE which does not support gapless MsgA configuration may favor cells which only have MsgA resource configurations with gaps or cells which have at least one or some MsgA resource configuration(s) with gap(s), while a cell which does not have any MsgA resource configuration with gap (i.e. only gapless MsgA resource configuration(s) or only 4-step RA configuration(s)) would be (re)selected only if its channel quality is more than the offset better than any other candidate cell which does have MsgA resource configuration(s) with gap(s).

As further variations, the UE may apply different offsets to a cell's channel quality depending on further aspects of the random access configuration in the cell, such as the density (e.g. the density in the time domain) of PRACH occasions or PRACH occasions for 2-step RA, or whether the cell is configured with both gapless and non-gapless MsgA resources, or whether the cell supports both 4-step RA and 2-step RA or only 2-step RA or only 4-step RA. When relevant, application of the offset(s) still depends on the UE's capabilities, i.e. the UE's support or lack of support for gapless MsgA transmission or the UE's support or lack of support for 2-step RA.

The offset(s) to apply may be signaled to the UE via the system information or dedicated signaling, e.g. dedicated RRC signaling. In the latter case, the offset(s) may be signaled in an RRCRelease message. Alternatively, the UE may be configured to, and/or implemented to, determine the size(s) of the offset(s) based on its capabilities.

If the UE is not configured with the capability to support gap-less MsgA transmission, during cell selection and reselection procedure, the UE selects a suitable cell to camp on not only considering the ordinary measurements in terms of DL radio quality, but also considering if the cell supports gap-less MsgA transmission. The UE selects the cell providing strongest DL radio connection (e.g., in terms of RSRP or RSRQ) and that does not require support of gap-less MsgA transmission.

Similarly, as described above, a UE may also employ an “integrated” cell (re)selection strategy, where the cell's gapless/non-gapless MsgA resource configuration and the cell's channel quality are consider in a weighted combination, e.g. adding an offset to a measured channel quality depending on the cell's MsgA resource configuration (in terms of gapless configurations, non-gapless configurations and mixture of gapless and non-gapless configurations).

As another embodiment, the UE selects an RO and a corresponding PO depending on whether it supports gap-less msgA transmission or not. In this case if the UE supports gap-less msgA transmission:
The UE is either free to select any RO/PO irrespective of if this will give a gap-less msgA transmission or
The UE must select a RO/PO giving a gap-less msgA transmission.

The alternative of selecting any RO/PO for UEs that support gap-less transmission may have the benefit that all available resources can be used by gap-less UEs, which maximizes their usage when UEs accessing the cell tend to have gap-less capability. The alternative of selecting only gap-less ROs may have the benefit of ensuring that POs used in gap-less transmission are used as much as possible, which could be when a relatively small number of UEs accessing a cell have gap-less capability.

In case the UE does not support gap-less msgA transmission, the UE may only select cells which do not support gap-less msgA transmission. Or, the UE may also select cells which support both gap-less msgA transmission and msgA transmission with gap. In this latter case, the UE may only select ROs/POs giving msgA transmission with gap between PRACH and msgA PUSCH, or select any RO/PO and only transmit preamble in case the select RO/PO gives a msgA transmission without gap. In case only the preamble is transmitted, the network can respond with a fallback RAR.

For a UE not supporting gap-less transmission, a benefit of selecting only cells that do not support gap-less transmission is that these less capable UEs will not add to the cell load of cells serving both UEs with gap-less and without gap-less capability. The alternative of UEs without gap-less capability accessing cells serving both types of UEs has the benefit that UEs without gap-less capability will generally be able to find better serving cells, since more choices of cells will be available to them.

The UE may also select a cell which only supports gap-less msgA transmission. In this case the UE only transmit preamble and the network responds with a fallback RAR, or the UE does a 4-step RA if this is supported in the cell.

UEs not supporting gap-less transmission transmitting only preambles has the benefit of reducing load on the POs and enabling a UE without gap-less support to access a cell, but will make less efficient use of 2-step RACH operation, since the information carried on the POs must be conveyed through the fallback procedure.

Autonomous Selection of Preamble—PUSCH Occasion (or PUSCH Resource Unit) Pairs Based on Delay

The physical characteristics or settings of different physical signals or channels that a UE transmits may be different. For example, the transmitted power, occupied PRBs, and antennas that the UE transmits on all can vary. Therefore, when a UE transmits different physical channels such as a PRACH and a PUSCH in adjacent slots, it may need some time for its hardware to adapt, its transmitted power level to settle, or its transmit chains to switch among antennas. Therefore, NR specifications sometimes restrict the minimum delay with which the UE is permitted to transmit different physical channel types that adjacent in time, such as the PUSCH and PRACH. Since lower delays between different physical channel types can lead to greater complexity, UE capabilities may be defined according to the minimum delay the UE can support.

LBT procedures also impose delay requirements between transmissions of a UE, as discussed above. Depending on the LBT category, the UE must determine if the channel is occupied prior to transmitting if the delay from a prior transmission is greater than some amount. If the delay is small enough, the UE can transmit without sensing the channel, but otherwise must first sense the channel.

It can be seen that a UE supporting shared channel access with LBT must support conflicting requirements when operating an LBT procedure: it must take into account any minimum delay requirements imposed by the need for the UE's hardware to adapt while still meeting the maximum delay requirement for transmission without a LBT procedure or using a shortened LBT procedure. A further complicating factor is that the network is heretofore not aware of whether the UE is capable of supporting a minimum delay between PRACH and PUSCH prior to initial access, and therefore the UE may need to autonomously select which RO-PO combinations meet both its minimum hardware imposed delay and LBT maximum delay (i.e. the maximum gap between RO and PO allowed for MsgA PUSCH transmission without a preceding LBT procedure). Therefore, an embodiment is needed wherein the UE determines if an RO-PO combination meets a delay requirement imposed by its hardware capability and a second delay requirement in an LBT procedure, wherein the network provides RO and PO configurations that may or may not meet the UE's delay requirements.

In some embodiments of a random access procedure, the UE receives a first and a second configuration identifying an RO and a PO, respectively. The UE then receives a first and a second configuration identifying a random access preamble occasion (‘RO’) and a PUSCH transmission occasion (‘PO’), respectively. The UE determines a delay between the end of a random access preamble transmission in the RO and the start of the PO from the first and second configurations. When the delay is not more than a first predetermined value, the UE transmits a random access preamble in its RO. The UE is identified as supporting transmission of the random access preamble followed by a PUSCH at a delay not more than the first predetermined value, but the UE may not necessarily indicate to the network that it supports this RO-PO delay prior to the random access procedure. When the delay is not less than a second value, the UE determines if a slot is idle and transmits the PUSCH in its PO if the slot is idle. When the delay is less than the second value, the UE transmits the PUSCH in its PO.

Two-step RACH procedures may require the UE to use RACH preambles specifically designated for use in the two-step procedure when the RSRP of an SSB (or CSI-RS) associated with the RACH preambles is greater than a threshold. This use of different RACH preambles for 2-step and 4-step RACH is in order to differentiate the UEs, since the network has no other indication of which procedure a UE uses for random access. If there is no RO-PO combination that meets the UEs minimum delay capability, then the UE will not be able to access a cell using 2-step RACH resources. One way to solve this problem is to allow the UE to select another cell when no RO-PO combination can be found that meets the UE's minimum delay capability. An alternative solution is to make an exception to the constraint that the UE must use 2-step random access resources when it has selected the two step procedure, where when the UE does not find an RO-PO combination that meets its delay requirements, it instead follows the 4-step random access procedure, transmitting a RACH preamble that is used for 4 step operation. This alternative solution has the benefit that the UE can still access a cell that it is near to (i.e. that has a relatively large RSRP), rather than being forced to select another cell for two step operation that meets its RO-PO delay requirements.

Therefore, in some embodiments of a random access procedure, a UE receives a first and a second configuration identifying a random access preamble occasion (‘RO’) and a PUSCH transmission occasion (‘PO’), respectively. The UE determines a delay between the end of a random access preamble transmission in the RO and the start of the PO from the first and second configurations. When the delay is not more than a first predetermined value, the UE transmits a random access preamble in its RO and a PUSCH in its PO. When the delay is more than the first predetermined value, the UE transmits a second random access preamble not associated with a PUSCH.

Two-step random access allows low latency random access procedures, and so in scenarios where low latency is desirable, a network may choose to configure its random access resources primarily for two step operation. In these scenarios, there may be little or no 4-step RACH resource available, and when a UE is not able to find RO-PO combinations that meet its delay requirements, it may also not be able to use 4-step RACH procedures. A solution to this problem can be to instead allow the UE to transmit a RACH preamble associated with 2-step operation without transmitting a msgA PUSCH. Since the network will not generally know the delay capability of UEs, it will not be able to infer if the configuration it provides meets the UE's delay requirements, and so will not generally know if the UE actually transmits a msgA PUSCH. If the network does not know, and it does not want to use 4-step access, it might allow the UE to repeatedly transmit in the two step RACH procedure, and continue to attempt to decode msgA PUSCHs that are not actually transmitted, wasting resources and delaying the UE's access to the cell. The network may thus, as one alternative, indicate fallback to 4-step RA operation by transmitting a fallbackRAR to the UE when it receives a 2-step RA preamble without receiving an associated MsgA PUSCH transmission. Another alternative is to attempt to perform energy detection on the msgA PUSCH DMRS and/or the msgA PUSCH resource elements that carry UL-SCH in order to estimate if the msgA PUSCH was actually transmitted. If the gNB determines that a preamble is transmitted without a PUSCH, then the network can choose to indicate a fallback to 4-step operation (i.e. transmit a fallbackRAR to the UE). In this way, those UEs that do not transmit a PUSCH because the PO is too close to the RO can be directed to 4-step operation, while UEs that transmitted a PUSCH that was not received by the network can still continue to use 2-step operation. The network can also indicate fallback.

Therefore, in some embodiments of a random access procedure, a UE receives a first and a second configuration identifying a random access preamble occasion (‘RO’) and a PUSCH transmission occasion (‘PO’), respectively. The UE determines a delay between the end of a random access preamble transmission in the RO and the start of the PO from the first and second configurations. When the delay is not more than a first predetermined value, the UE transmits a random access preamble in its RO and a PUSCH in its PO. When the delay is more than the first predetermined value, the UE transmits the random access preamble.

On Applying the Gap Requirement Between MsgA Preamble Part and MsgA PUSCH Part for RA Type Selection in CFRA or CBRA

In NR release 16, the RA type selection between 2-step RA and 4-step RA is determined according to following procedures.

For CFRA, only one of the RA types is supported at the same time and whether 2-step RA or 4-step RA can be selected depends on what RA type the CFRA resource is configured for. The UE may also select CBRA resources when the configured CFRA resources do not meet associated channel quality requirements.

For CBRA, if both 2-step RACH and 4-step RACH are configured, msgA-RSRP-Threshold.or msgA-RSRP-ThresholdSUL is used for selection of RA type for the cases without SUL configured or with SUL configured respectively. 2-step RACH only random access procedures can also be supported in CBRA.

Taking into account the gap requirements for UEs with different capabilities in the RA type selection and in the RA resource allocation, embodiments herein include the following:

Embodiment 1: For CFRA, when the UE capability is known (e.g. when UE is in RRC connected mode) by the network, the network determines the RA type via configuring the corresponding CFRA resources in the dedicated signaling for the RA type based on the UE capability of handle gapless MsgA.

E.g. if UE is capable of handling gapless MsgA, network can configure CFRA resource for 2-step RA type, otherwise configure CFRA resource for 4-step RA type.

In a variant of embodiment 1, the network configures a CFRA resource for 2-step RA type and configures a proper slot offset value between an RO or a set of ROs in one PRACH slot and a PO according to the UE capabilities of handling the MsgAs with different gaps between MsgA preamble part and MsgA PUSCH part.

As an example, for a UE capable of transmitting gapless MsgA, the network can, in the dedicated signaling, schedule an PO right after a RO (e.g. the last RO of one PRACH slot) and also enable CP extension if needed so that single LBT or less LBT time is needed for the whole MsgA transmission.

Embodiment 2: for CBRA, how to determine a gap between preamble or PUSCH depends on whether both RA types are configured.

In one variant of embodiment 2, when only 2-step RA type is configured, a UE determines a MsgA resource with one or more of the following methods. The UE selects the PRACH resources according the SSB selection and determines a PO with some DMRS configuration according to the existing procedures defined in TS 38.213 v16.0.0. When the PO is too close to the RO that the UE can not handle, The PUSCH is discarded, or the whole MsgA is discarded, or the UE selects another SSB. If the PUSCH is discarded, the UE does the preamble only MsgA transmission. In this case, network can either do fallback when MsgA PUSCH is not decoded or do nothing to let the MsgB window expire and UE may do a reattempt so that a MsgA resource meeting the gap requirement can be selected afterwards. On the other hand, if the whole MsgA is discarded, the UE will wait for the next time instance for RO and preamble selection. Or, if the UE selects another SSB, the UE selects an SSB with SS-RSRP above rsrp-ThresholdSSB or the CSI-RS with CSI-RSRP above rsrp-ThresholdCSl-RS, so that a proper MsgA resource with a proper gap between preamble and PUSCH can be determined

In another variant of embodiment 2, when both 2-step RA and 4-step RA types are configured, besides the methods mentioned in previous variant of embodiment 2, UE selects a 4-step RA type when gapless MsgA or a MsgA with small gap between preamble/PUSCH part is not able to be handled as discussed above.

This method introduces new rules for RA type selection. As an example, the following updated RA type selection procedure can be applied (revised from 3GPP TS 38.321):
. . .
1> 1> if random access procedure is initiated by PDCCH order and if the ra-PreambleIndex explicitly provided by PDCCH is not 0b000000 or
1> 1> if the Random Access procedure was initiated for SI request (as specified in TS 38.331 [5]) and the Random Access Resources for SI request have been explicitly provided by RRC or
1> 1> if the Random Access procedure was initiated for beam failure recovery (as specified in clause 5.17) and if the contention-free Random Access Resources for beam failure recovery request for 4-step RA type have been explicitly provided by RRC for the BWP selected for random access procedure; or
1> 1> if the Random Access procedure was initiated for reconfiguration with sync and if the contention-free Random Access Resources for 4-step RA type have been explicitly provided in rach-ConfigDedicated for the BWP selected for random access:
   2> set the RA_TYPE to 4-stepRA;
1> 1> else if the BWP selected for random access procedure is configured with both 2-step and 4-step RA type random access resources and if the MsgA resource determined by UE has a gap no less than the minimum requirement according to the UE's capability and the RSRP of the downlink pathloss reference is above RSRP_THRESHOLD_RA_TYPE_SELECTION; or
1> 1> if the BWP selected for random access procedure is only configured with 2-step RA type random access resources (i.e. no 4-step RACH RA type resources configured) or
1> 1> if the Random Access procedure was initiated for reconfiguration with sync and if the contention-free Random Access Resources for 2-step RA type have been explicitly provided in rach-ConfigDedicated for the BWP selected for random access:
   2> set the RA_TYPE to 2-pRA;
1> 1> else:
   2> set the RA_TYPE to 4-pRA;
1> 1> perform initialization of variables specific to random access type as specified in sub-clause 5.1.1a;
. . .

Some Further Aspects of UE Behavior when the UE does not Support Gapless MsgA Transmission

A scenario which may deserve some attention is where a UE does not support gapless MsgA transmission and is faced with different situations in terms of the available RA configurations in a cell.

If the cell is configured with both gapless and non-gapless RO-PO combinations for 2-step RA, the UE should attempt to select an RO-PO which is configured with a gap (where the gap should be large enough to meet the UE's capability).

If this is not possible, e.g. because only gapless RO-PO combinations are configured for 2-step RA in the cell, the UE will not be able to transmit a complete MsgA (i.e. a preamble with an associated MsgA PUSCH transmission) and has to find another approach.

To this end, in consideration of the RA configuration in the cell (including e.g. presence of only gapless RO-PO combinations, presence of only non-gapless RO-PO combinations or presence of both gapless and non-gapless RO-PO combinations), a UE which supports 2-step RA, but does not support gapless MsgA transmission, may apply e.g. one of the following alternative strategies in accordance with different embodiments:
1. The UE selects 4-step RA and if no 4-step RA configuration exists in the cell, the UE regards the cell as inaccessible.
2. The UE selects 4-step RA and if no 4-step RA configuration exists in the cell, the UE selects a 2-step PRACH occasion and transmits a preamble but skips the MsgA PUSCH transmission, which will result in fallback to 4-step RA.
3. The UE selects the first available PRACH occasion, irrespective of whether it is a 4-step RO or a 2-step RO. If it is a 2-step RO, the result will be fallback to 4-step RA, since the UE will skip the MsgA PUSCH transmission.
4. The UE selects a 2-step RO-PO combination, e.g. the first available 2-step RO, and the result will be fallback to 4-step RA, since the UE will skip the MsgA PUSCH transmission.

As another option, more than one of the above strategies may be specified or available for a UE and the network may configure the UE with which strategy to use (or the UE may autonomously choose which strategy to apply).

The following illustrates how the above strategies could be supported in in the RA type selection procedure description in the MAC specification 3GPP TS 38.321, based on the text in sections 5.1.1 in the current version of the specification (in the form of a not yet stable and approved change request), which is version 15.8.0.
:
:

1> else if the BWP selected for random access procedure is configured with both 2-step and 4-step RA type random access resources and the RSRP of the downlink pathloss reference is above RSRP_THRESHOLD_RA_TYPE_SELECTION and at least one RO-PO combination configured in the BWP has a gap larger than <someParameterIndicatingTheUEsMinimumGapCapability>; or
1> if the BWP selected for random access procedure is only configured with 2-step RA type random access resources (i.e. no 4-step RACH RA type resources configured); or

Note: This condition together with the level 2 statement below (i.e. “set the RA_TYPE to 2-stepRA”) covers (like an umbrella) strategy 2. It would have to be complemented with modified logic in the procedures for selecting RA resource and transmitting in the resource, so that the length of the gap in relation to the UE capability is taken into account such that the UE first attempts to select a RO-PO combination where the gap is large enough and, if no such RO-PO combination is available, transmits only a 2-step RA preamble. For strategy 1 to work, this logic would have to be rewritten to avoid that the RA_TYPE is set to 2-stepRA when the gap is too short and that the UE in that case instead should regard the cell/BWP as inaccessible/barred.

1> if the Random Access procedure was initiated for reconfiguration with sync and if the contention-free Random Access Resources for 2-step RA type have been explicitly provided in rach-ConfigDedicated for the BWP selected for random access:
2> set the RA_TYPE to 2-stepRA;

1> else if the BWP selected for random access procedure is configured with both 2-step and 4-step RA type random access resources and the RSRP of the downlink pathloss reference is above RSRP_THRESHOLD_RA_TYPE_SELECTION and none of the RO-PO combinations configured in the BWP has a gap larger than <someParameterIndicatingTheUEsMinimumGapCapability>:

From this point, the logic differs between strategies 1-4:

——————Strategy 1 (Assuming Some Logic Rewriting According to the Note Above)————
2> set the RA_TYPE to 4-stepRA;

1> else if the BWP selected for random access procedure is configured with only 2-step RA type random access resources (i.e. no 4-step RA configured in the BWP) and the RSRP of the downlink pathloss reference is above below RSRP_THRESHOLD_RA_TYPE_SELECTION or none of the RO-PO combinations configured in the BWP has a gap larger than <someParameterIndicatingTheUEsMinimumGapCapability>:
2> consider the cell as inaccessible (no BWP switch considered since not since I assume that the network will ensure that the situation will not occur for a UE in RRC_CONNECTED state . . . hmm . . . well it could if the RA type selection threshold is not exceeded, but that is not really relevant for the invention . . . ).

——————Strategy 2 (this is Essentially Already Covered Above, as Described in the Note Above, but Otherwise Logic Along the Following Lines could Cover it) ——————
2> set the RA_TYPE to 4-stepRA;

1> else if the BWP selected for random access procedure is configured with only 2-step RA type random access resources (i.e. no 4-step RA configured in the BWP) (regardless of the RSRP and regardless of the gaps of the RO-PO combinations configured in the BWP):
2> set the RA_TYPE to 2-stepRA; (Possibly, the UE should instead regard the cell as inaccessible if the RA type RSRP selection threshold is not exceeded? I haven't checked how this is specified today in the CR.)

——————Strategy 3——————
2> if the first available PRACH occasion is configured for the 2-step RA type, set the RA_TYPE to 2-stepRA; (Here I guess “available” should depend on the selected SSB. And note that this would have to be complemented with modified logic in the procedures for selecting RA resource and transmitting in the resource, so that the length of the gap in relation to the UE capability is taken into account such that the UE first attempts to select a RO-PO combination where the gap is large enough and, if no such RO-PO combination is available, transmits only a 2-step RA preamble.)
2> else set the RA_TYPE to 4-stepRA; (Note that the case where 4-step RA is not configured for the BWP is already covered further above.)

——————Strategy 4 ——————
2> set the RA_TYPE to 2-stepRA; (Note that this would have to be complemented with modified logic in the procedures for selecting RA resource and transmitting in the resource, so that the length of the gap in relation to the UE capability is taken into account such that the UE first attempts to select a RO-PO combination where the gap is large enough and, if no such RO-PO combination is available, transmits only a 2-step RA preamble.)

Note that the above described embodiments typically refer to the RA configuration of a cell. However, embodiments herein are equally applicable when the cell is replaced by a BWP in this context. That is, the various aspects related to RA configurations may be related to the RA configurations of a BWP rather than a cell.

Moreover, in some of the embodiments previously described herein, the UE is assumed to signal its capability in relation to gapless MsgA transmission to the UE (i.e. whether it is capable of gapless MsgA transmission), but most of the embodiments are applicable irrespective of whether the UE's support or no support for gapless MsgA transmission is signaled to the network. For example, such embodiments include embodiments describing a UE's behavior depending on the combination of UE gapless MsgA transmission capability (supporting it or not) and the network's MsgA resource configuration (only MsgA resources without gap, only MsgA resources with gap or both MsgA resources without gap and MsgA resources with gap).

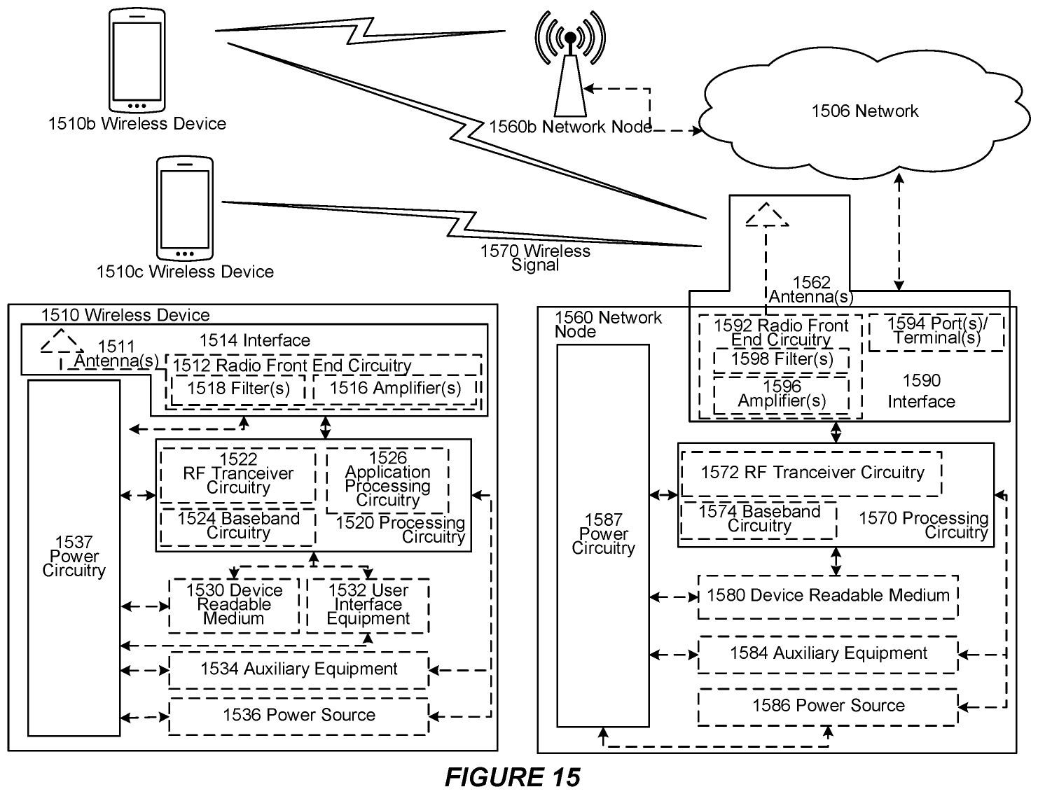

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 1506, network nodes 1560 and 1560b, and WDs 1510, 1510b, and 1510c. In practice, a wireless network may further include any additional elements suitable to support communication between wireless devices or between a wireless device and another communication device, such as a landline telephone, a service provider, or any other network node or end device. Of the illustrated components, network node 1560 and wireless device (WD) 1510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1560 and WD 1510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 1560 includes processing circuitry 1570, device readable medium 1580, interface 1590, auxiliary equipment 1584, power source 1586, power circuitry 1587, and antenna 1562. Although network node 1560 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1560 are depicted as single boxes located within a larger box, or nested within multiple boxes, in practice, a network node may comprise multiple different physical components that make up a single illustrated component (e.g., device readable medium 1580 may comprise multiple separate hard drives as well as multiple RAM modules).

Similarly, network node 1560 may be composed of multiple physically separate components (e.g., a NodeB component and a RNC component, or a BTS component and a BSC component, etc.), which may each have their own respective components. In certain scenarios in which network node 1560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1560 may be configured to support multiple radio access technologies (RATs). In such embodiments, some components may be duplicated (e.g., separate device readable medium 1580 for the different RATs) and some components may be reused (e.g., the same antenna 1562 may be shared by the RATs). Network node 1560 may also include multiple sets of the various illustrated components for different wireless technologies integrated into network node 1560, such as, for example, GSM, WCDMA, LTE, NR, WiFi, or Bluetooth wireless technologies. These wireless technologies may be integrated into the same or different chip or set of chips and other components within network node 1560.

Processing circuitry 1570 is configured to perform any determining, calculating, or similar operations (e.g., certain obtaining operations) described herein as being provided by a network node. These operations performed by processing circuitry 1570 may include processing information obtained by processing circuitry 1570 by, for example, converting the obtained information into other information, comparing the obtained information or converted information to information stored in the network node, and/or performing one or more operations based on the obtained information or converted information, and as a result of said processing making a determination.

Processing circuitry 1570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1560 components, such as device readable medium 1580, network node 1560 functionality. For example, processing circuitry 1570 may execute instructions stored in device readable medium 1580 or in memory within processing circuitry 1570. Such functionality may include providing any of the various wireless features, functions, or benefits discussed herein. In some embodiments, processing circuitry 1570 may include a system on a chip (SOC).

In some embodiments, processing circuitry 1570 may include one or more of radio frequency (RF) transceiver circuitry 1572 and baseband processing circuitry 1574. In some embodiments, radio frequency (RF) transceiver circuitry 1572 and baseband processing circuitry 1574 may be on separate chips (or sets of chips), boards, or units, such as radio units and digital units. In alternative embodiments, part or all of RF transceiver circuitry 1572 and baseband processing circuitry 1574 may be on the same chip or set of chips, boards, or units

In certain embodiments, some or all of the functionality described herein as being provided by a network node, base station, eNB or other such network device may be performed by processing circuitry 1570 executing instructions stored on device readable medium 1580 or memory within processing circuitry 1570. In alternative embodiments, some or all of the functionality may be provided by processing circuitry 1570 without executing instructions stored on a separate or discrete device readable medium, such as in a hard-wired manner. In any of those embodiments, whether executing instructions stored on a device readable storage medium or not, processing circuitry 1570 can be configured to perform the described functionality. The benefits provided by such functionality are not limited to processing circuitry 1570 alone or to other components of network node 1560, but are enjoyed by network node 1560 as a whole, and/or by end users and the wireless network generally.

Device readable medium 1580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1570. Device readable medium 1580 may store any suitable instructions, data or information, including a computer program, software, an application including one or more of logic, rules, code, tables, etc. and/or other instructions capable of being executed by processing circuitry 1570 and, utilized by network node 1560. Device readable medium 1580 may be used to store any calculations made by processing circuitry 1570 and/or any data received via interface 1590. In some embodiments, processing circuitry 1570 and device readable medium 1580 may be considered to be integrated.

Interface 1590 is used in the wired or wireless communication of signalling and/or data between network node 1560, network 1506, and/or WDs 1510. As illustrated, interface 1590 comprises port(s)/terminal(s) 1594 to send and receive data, for example to and from network 1506 over a wired connection. Interface 1590 also includes radio front end circuitry 1592 that may be coupled to, or in certain embodiments a part of, antenna 1562. Radio front end circuitry 1592 comprises filters 1598 and amplifiers 1596. Radio front end circuitry 1592 may be connected to antenna 1562 and processing circuitry 1570. Radio front end circuitry may be configured to condition signals communicated between antenna 1562 and processing circuitry 1570. Radio front end circuitry 1592 may receive digital data that is to be sent out to other network nodes or WDs via a wireless connection. Radio front end circuitry 1592 may convert the digital data into a radio signal having the appropriate channel and bandwidth parameters using a combination of filters 1598 and/or amplifiers 1596. The radio signal may then be transmitted via antenna 1562. Similarly, when receiving data, antenna 1562 may collect radio signals which are then converted into digital data by radio front end circuitry 1592. The digital data may be passed to processing circuitry 1570. In other embodiments, the interface may comprise different components and/or different combinations of components.

In certain alternative embodiments, network node 1560 may not include separate radio front end circuitry 1592, instead, processing circuitry 1570 may comprise radio front end circuitry and may be connected to antenna 1562 without separate radio front end circuitry 1592. Similarly, in some embodiments, all or some of RF transceiver circuitry 1572 may be considered a part of interface 1590. In still other embodiments, interface 1590 may include one or more ports or terminals 1594, radio front end circuitry 1592, and RF transceiver circuitry 1572, as part of a radio unit (not shown), and interface 1590 may communicate with baseband processing circuitry 1574, which is part of a digital unit (not shown).

Antenna 1562 may include one or more antennas, or antenna arrays, configured to send and/or receive wireless signals. Antenna 1562 may be coupled to radio front end circuitry 1590 and may be any type of antenna capable of transmitting and receiving data and/or signals wirelessly. In some embodiments, antenna 1562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1562 may be separate from network node 1560 and may be connectable to network node 1560 through an interface or port.

Antenna 1562, interface 1590, and/or processing circuitry 1570 may be configured to perform any receiving operations and/or certain obtaining operations described herein as being performed by a network node. Any information, data and/or signals may be received from a wireless device, another network node and/or any other network equipment. Similarly, antenna 1562, interface 1590, and/or processing circuitry 1570 may be configured to perform any transmitting operations described herein as being performed by a network node. Any information, data and/or signals may be transmitted to a wireless device, another network node and/or any other network equipment.

Power circuitry 1587 may comprise, or be coupled to, power management circuitry and is configured to supply the components of network node 1560 with power for performing the functionality described herein. Power circuitry 1587 may receive power from power source 1586. Power source 1586 and/or power circuitry 1587 may be configured to provide power to the various components of network node 1560 in a form suitable for the respective components (e.g., at a voltage and current level needed for each respective component). Power source 1586 may either be included in, or external to, power circuitry 1587 and/or network node 1560. For example, network node 1560 may be connectable to an external power source (e.g., an electricity outlet) via an input circuitry or interface such as an electrical cable, whereby the external power source supplies power to power circuitry 1587. As a further example, power source 1586 may comprise a source of power in the form of a battery or battery pack which is connected to, or integrated in, power circuitry 1587. The battery may provide backup power should the external power source fail. Other types of power sources, such as photovoltaic devices, may also be used.

Alternative embodiments of network node 1560 may include additional components beyond those shown in FIG. 15 that may be responsible for providing certain aspects of the network node's functionality, including any of the functionality described herein and/or any functionality necessary to support the subject matter described herein. For example, network node 1560 may include user interface equipment to allow input of information into network node 1560 and to allow output of information from network node 1560. This may allow a user to perform diagnostic, maintenance, repair, and other administrative functions for network node 1560.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1510 includes antenna 1511, interface 1514, processing circuitry 1520, device readable medium 1530, user interface equipment 1532, auxiliary equipment 1534, power source 1536 and power circuitry 1537. WD 1510 may include multiple sets of one or more of the illustrated components for different wireless technologies supported by WD 1510, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1510.

Antenna 1511 may include one or more antennas or antenna arrays, configured to send and/or receive wireless signals, and is connected to interface 1514. In certain alternative embodiments, antenna 1511 may be separate from WD 1510 and be connectable to WD 1510 through an interface or port. Antenna 1511, interface 1514, and/or processing circuitry 1520 may be configured to perform any receiving or transmitting operations described herein as being performed by a WD. Any information, data and/or signals may be received from a network node and/or another WD. In some embodiments, radio front end circuitry and/or antenna 1511 may be considered an interface.

As illustrated, interface 1514 comprises radio front end circuitry 1512 and antenna 1511. Radio front end circuitry 1512 comprise one or more filters 1518 and amplifiers 1516. Radio front end circuitry 1514 is connected to antenna 1511 and processing circuitry 1520, and is configured to condition signals communicated between antenna 1511 and processing circuitry 1520. Radio front end circuitry 1512 may be coupled to or a part of antenna 1511. In some embodiments, WD 1510 may not include separate radio front end circuitry 1512; rather, processing circuitry 1520 may comprise radio front end circuitry and may be connected to antenna 1511. Similarly, in some embodiments, some or all of RF transceiver circuitry 1522 may be considered a part of interface 1514. Radio front end circuitry 1512 may receive digital data that is to be sent out to other network nodes or WDs via a wireless connection. Radio front end circuitry 1512 may convert the digital data into a radio signal having the appropriate channel and bandwidth parameters using a combination of filters 1518 and/or amplifiers 1516. The radio signal may then be transmitted via antenna 1511. Similarly, when receiving data, antenna 1511 may collect radio signals which are then converted into digital data by radio front end circuitry 1512. The digital data may be passed to processing circuitry 1520. In other embodiments, the interface may comprise different components and/or different combinations of components.

Processing circuitry 1520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1510 components, such as device readable medium 1530, WD 1510 functionality. Such functionality may include providing any of the various wireless features or benefits discussed herein. For example, processing circuitry 1520 may execute instructions stored in device readable medium 1530 or in memory within processing circuitry 1520 to provide the functionality disclosed herein.

As illustrated, processing circuitry 1520 includes one or more of RF transceiver circuitry 1522, baseband processing circuitry 1524, and application processing circuitry 1526. In other embodiments, the processing circuitry may comprise different components and/or different combinations of components. In certain embodiments processing circuitry 1520 of WD 1510 may comprise a SOC. In some embodiments, RF transceiver circuitry 1522, baseband processing circuitry 1524, and application processing circuitry 1526 may be on separate chips or sets of chips. In alternative embodiments, part or all of baseband processing circuitry 1524 and application processing circuitry 1526 may be combined into one chip or set of chips, and RF transceiver circuitry 1522 may be on a separate chip or set of chips. In still alternative embodiments, part or all of RF transceiver circuitry 1522 and baseband processing circuitry 1524 may be on the same chip or set of chips, and application processing circuitry 1526 may be on a separate chip or set of chips. In yet other alternative embodiments, part or all of RF transceiver circuitry 1522, baseband processing circuitry 1524, and application processing circuitry 1526 may be combined in the same chip or set of chips. In some embodiments, RF transceiver circuitry 1522 may be a part of interface 1514. RF transceiver circuitry 1522 may condition RF signals for processing circuitry 1520.

In certain embodiments, some or all of the functionality described herein as being performed by a WD may be provided by processing circuitry 1520 executing instructions stored on device readable medium 1530, which in certain embodiments may be a computer-readable storage medium. In alternative embodiments, some or all of the functionality may be provided by processing circuitry 1520 without executing instructions stored on a separate or discrete device readable storage medium, such as in a hard-wired manner. In any of those particular embodiments, whether executing instructions stored on a device readable storage medium or not, processing circuitry 1520 can be configured to perform the described functionality. The benefits provided by such functionality are not limited to processing circuitry 1520 alone or to other components of WD 1510, but are enjoyed by WD 1510 as a whole, and/or by end users and the wireless network generally.

Processing circuitry 1520 may be configured to perform any determining, calculating, or similar operations (e.g., certain obtaining operations) described herein as being performed by a WD. These operations, as performed by processing circuitry 1520, may include processing information obtained by processing circuitry 1520 by, for example, converting the obtained information into other information, comparing the obtained information or converted information to information stored by WD 1510, and/or performing one or more operations based on the obtained information or converted information, and as a result of said processing making a determination.

Device readable medium 1530 may be operable to store a computer program, software, an application including one or more of logic, rules, code, tables, etc. and/or other instructions capable of being executed by processing circuitry 1520. Device readable medium 1530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1520. In some embodiments, processing circuitry 1520 and device readable medium 1530 may be considered to be integrated.

User interface equipment 1532 may provide components that allow for a human user to interact with WD 1510. Such interaction may be of many forms, such as visual, audial, tactile, etc. User interface equipment 1532 may be operable to produce output to the user and to allow the user to provide input to WD 1510. The type of interaction may vary depending on the type of user interface equipment 1532 installed in WD 1510. For example, if WD 1510 is a smart phone, the interaction may be via a touch screen; if WD 1510 is a smart meter, the interaction may be through a screen that provides usage (e.g., the number of gallons used) or a speaker that provides an audible alert (e.g., if smoke is detected). User interface equipment 1532 may include input interfaces, devices and circuits, and output interfaces, devices and circuits. User interface equipment 1532 is configured to allow input of information into WD 1510, and is connected to processing circuitry 1520 to allow processing circuitry 1520 to process the input information. User interface equipment 1532 may include, for example, a microphone, a proximity or other sensor, keys/buttons, a touch display, one or more cameras, a USB port, or other input circuitry. User interface equipment 1532 is also configured to allow output of information from WD 1510, and to allow processing circuitry 1520 to output information from WD 1510. User interface equipment 1532 may include, for example, a speaker, a display, vibrating circuitry, a USB port, a headphone interface, or other output circuitry. Using one or more input and output interfaces, devices, and circuits, of user interface equipment 1532, WD 1510 may communicate with end users and/or the wireless network, and allow them to benefit from the functionality described herein.

Auxiliary equipment 1534 is operable to provide more specific functionality which may not be generally performed by WDs. This may comprise specialized sensors for doing measurements for various purposes, interfaces for additional types of communication such as wired communications etc. The inclusion and type of components of auxiliary equipment 1534 may vary depending on the embodiment and/or scenario.

Power source 1536 may, in some embodiments, be in the form of a battery or battery pack. Other types of power sources, such as an external power source (e.g., an electricity outlet), photovoltaic devices or power cells, may also be used. WD 1510 may further comprise power circuitry 1537 for delivering power from power source 1536 to the various parts of WD 1510 which need power from power source 1536 to carry out any functionality described or indicated herein. Power circuitry 1537 may in certain embodiments comprise power management circuitry. Power circuitry 1537 may additionally or alternatively be operable to receive power from an external power source; in which case WD 1510 may be connectable to the external power source (such as an electricity outlet) via input circuitry or an interface such as an electrical power cable. Power circuitry 1537 may also in certain embodiments be operable to deliver power from an external power source to power source 1536. This may be, for example, for the charging of power source 1536. Power circuitry 1537 may perform any formatting, converting, or other modification to the power from power source 1536 to make the power suitable for the respective components of WD 1510 to which power is supplied.

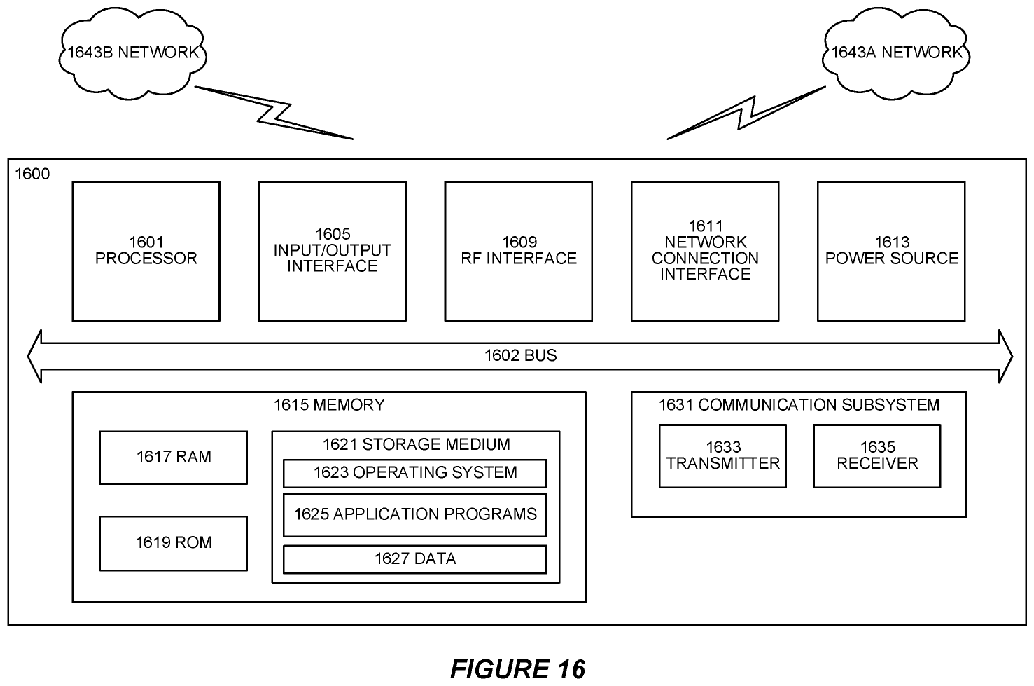

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 16200 may be any UE identified by the 3^{rd} Generation Partnership Project (3GPP), including a NB-IoT UE, a machine type communication (MTC) UE, and/or an enhanced MTC (eMTC) UE. UE 1600, as illustrated in FIG. 16, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 1600 includes processing circuitry 1601 that is operatively coupled to input/output interface 1605, radio frequency (RF) interface 1609, network connection interface 1611, memory 1615 including random access memory (RAM) 1617, read-only memory (ROM) 1619, and storage medium 1621 or the like, communication subsystem 1631, power source 1633, and/or any other component, or any combination thereof. Storage medium 1621 includes operating system 1623, application program 1625, and data 1627. In other embodiments, storage medium 1621 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 1601 may be configured to process computer instructions and data. Processing circuitry 1601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1601 may include two central processing units (CPUs). Data may be information in a form suitable for use by a computer.

In the depicted embodiment, input/output interface 1605 may be configured to provide a communication interface to an input device, output device, or input and output device. UE 1600 may be configured to use an output device via input/output interface 1605. An output device may use the same type of interface port as an input device. For example, a USB port may be used to provide input to and output from UE 1600. The output device may be a speaker, a sound card, a video card, a display, a monitor, a printer, an actuator, an emitter, a smartcard, another output device, or any combination thereof. UE 1600 may be configured to use an input device via input/output interface 1605 to allow a user to capture information into UE 1600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 1609 may be configured to provide a communication interface to RF components such as a transmitter, a receiver, and an antenna. Network connection interface 1611 may be configured to provide a communication interface to network 1643a. Network 1643a may encompass wired and/or wireless networks such as a local-area network (LAN), a wide-area network (WAN), a computer network, a wireless network, a telecommunications network, another like network or any combination thereof. For example, network 1643a may comprise a Wi-Fi network. Network connection interface 1611 may be configured to include a receiver and a transmitter interface used to communicate with one or more other devices over a communication network according to one or more communication protocols, such as Ethernet, TCP/IP, SONET, ATM, or the like. Network connection interface 1611 may implement receiver and transmitter functionality appropriate to the communication network links (e.g., optical, electrical, and the like). The transmitter and receiver functions may share circuit components, software or firmware, or alternatively may be implemented separately.

RAM 1617 may be configured to interface via bus 1602 to processing circuitry 1601 to provide storage or caching of data or computer instructions during the execution of software programs such as the operating system, application programs, and device drivers. ROM 1619 may be configured to provide computer instructions or data to processing circuitry 1601. For example, ROM 1619 may be configured to store invariant low-level system code or data for basic system functions such as basic input and output (I/O), startup, or reception of keystrokes from a keyboard that are stored in a non-volatile memory. Storage medium 1621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1621 may be configured to include operating system 1623, application program 1625 such as a web browser application, a widget or gadget engine or another application, and data file 1627. Storage medium 1621 may store, for use by UE 1600, any of a variety of various operating systems or combinations of operating systems.

Storage medium 1621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1621 may allow UE 1600 to access computer-executable instructions, application programs or the like, stored on transitory or non-transitory memory media, to off-load data, or to upload data. An article of manufacture, such as one utilizing a communication system may be tangibly embodied in storage medium 1621, which may comprise a device readable medium.

In FIG. 16, processing circuitry 1601 may be configured to communicate with network 1643b using communication subsystem 1631. Network 1643a and network 1643b may be the same network or networks or different network or networks. Communication subsystem 1631 may be configured to include one or more transceivers used to communicate with network 1643b. For example, communication subsystem 1631 may be configured to include one or more transceivers used to communicate with one or more remote transceivers of another device capable of wireless communication such as another WD, UE, or base station of a radio access network (RAN) according to one or more communication protocols, such as IEEE 802.16, CDMA, WCDMA, GSM, LTE, UTRAN, WiMax, or the like. Each transceiver may include transmitter 1633 and/or receiver 1635 to implement transmitter or receiver functionality, respectively, appropriate to the RAN links (e.g., frequency allocations and the like). Further, transmitter 1633 and receiver 1635 of each transceiver may share circuit components, software or firmware, or alternatively may be implemented separately.

In the illustrated embodiment, the communication functions of communication subsystem 1631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1631 may include cellular communication, Wi-Fi communication, Bluetooth communication, and GPS communication. Network 1643b may encompass wired and/or wireless networks such as a local-area network (LAN), a wide-area network (WAN), a computer network, a wireless network, a telecommunications network, another like network or any combination thereof. For example, network 1643b may be a cellular network, a Wi-Fi network, and/or a near-field network. Power source 1613 may be configured to provide alternating current (AC) or direct current (DC) power to components of UE 1600.

The features, benefits and/or functions described herein may be implemented in one of the components of UE 1600 or partitioned across multiple components of UE 1600. Further, the features, benefits, and/or functions described herein may be implemented in any combination of hardware, software or firmware. In one example, communication subsystem 1631 may be configured to include any of the components described herein. Further, processing circuitry 1601 may be configured to communicate with any of such components over bus 1602. In another example, any of such components may be represented by program instructions stored in memory that when executed by processing circuitry 1601 perform the corresponding functions described herein. In another example, the functionality of any of such components may be partitioned between processing circuitry 1601 and communication subsystem 1631. In another example, the non-computationally intensive functions of any of such components may be implemented in software or firmware and the computationally intensive functions may be implemented in hardware.

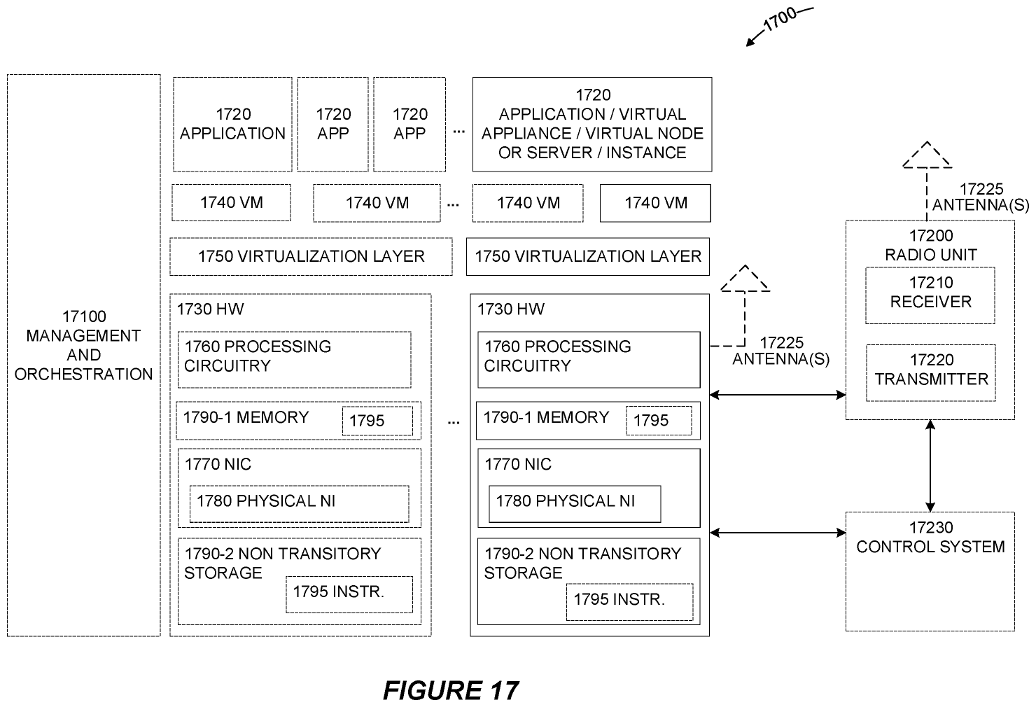

FIG. 17 is a schematic block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1700 hosted by one or more of hardware nodes 1730. Further, in embodiments in which the virtual node is not a radio access node or does not require radio connectivity (e.g., a core network node), then the network node may be entirely virtualized.

The functions may be implemented by one or more applications 1720 (which may alternatively be called software instances, virtual appliances, network functions, virtual nodes, virtual network functions, etc.) operative to implement some of the features, functions, and/or benefits of some of the embodiments disclosed herein. Applications 1720 are run in virtualization environment 1700 which provides hardware 1730 comprising processing circuitry 1760 and memory 1790. Memory 1790 contains instructions 1795 executable by processing circuitry 1760 whereby application 1720 is operative to provide one or more of the features, benefits, and/or functions disclosed herein.

Virtualization environment 1700, comprises general-purpose or special-purpose network hardware devices 1730 comprising a set of one or more processors or processing circuitry 1760, which may be commercial off-the-shelf (COTS) processors, dedicated Application Specific Integrated Circuits (ASICs), or any other type of processing circuitry including digital or analog hardware components or special purpose processors. Each hardware device may comprise memory 1790-1 which may be non-persistent memory for temporarily storing instructions 1795 or software executed by processing circuitry 1760. Each hardware device may comprise one or more network interface controllers (NICs) 1770, also known as network interface cards, which include physical network interface 1780. Each hardware device may also include non-transitory, persistent, machine-readable storage media 1790-2 having stored therein software 1795 and/or instructions executable by processing circuitry 1760. Software 1795 may include any type of software including software for instantiating one or more virtualization layers 1750 (also referred to as hypervisors), software to execute virtual machines 1740 as well as software allowing it to execute functions, features and/or benefits described in relation with some embodiments described herein.

Virtual machines 1740, comprise virtual processing, virtual memory, virtual networking or interface and virtual storage, and may be run by a corresponding virtualization layer 1750 or hypervisor. Different embodiments of the instance of virtual appliance 1720 may be implemented on one or more of virtual machines 1740, and the implementations may be made in different ways.

During operation, processing circuitry 1760 executes software 1795 to instantiate the hypervisor or virtualization layer 1750, which may sometimes be referred to as a virtual machine monitor (VMM). Virtualization layer 1750 may present a virtual operating platform that appears like networking hardware to virtual machine 1740.

As shown in FIG. 17, hardware 1730 may be a standalone network node with generic or specific components. Hardware 1730 may comprise antenna 17225 and may implement some functions via virtualization. Alternatively, hardware 1730 may be part of a larger cluster of hardware (e.g. such as in a data center or customer premise equipment (CPE)) where many hardware nodes work together and are managed via management and orchestration (MANO) 17100, which, among others, oversees lifecycle management of applications 1720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1740 may be a software implementation of a physical machine that runs programs as if they were executing on a physical, non-virtualized machine. Each of virtual machines 1740, and that part of hardware 1730 that executes that virtual machine, be it hardware dedicated to that virtual machine and/or hardware shared by that virtual machine with others of the virtual machines 1740, forms a separate virtual network elements (VNE).

Still in the context of NFV, Virtual Network Function (VNF) is responsible for handling specific network functions that run in one or more virtual machines 1740 on top of hardware networking infrastructure 1730 and corresponds to application 1720 in FIG. 17.

In some embodiments, one or more radio units 17200 that each include one or more transmitters 17220 and one or more receivers 17210 may be coupled to one or more antennas 17225. Radio units 17200 may communicate directly with hardware nodes 1730 via one or more appropriate network interfaces and may be used in combination with the virtual components to provide a virtual node with radio capabilities, such as a radio access node or a base station.

In some embodiments, some signalling can be effected with the use of control system 17230 which may alternatively be used for communication between the hardware nodes 1730 and radio units 17200.

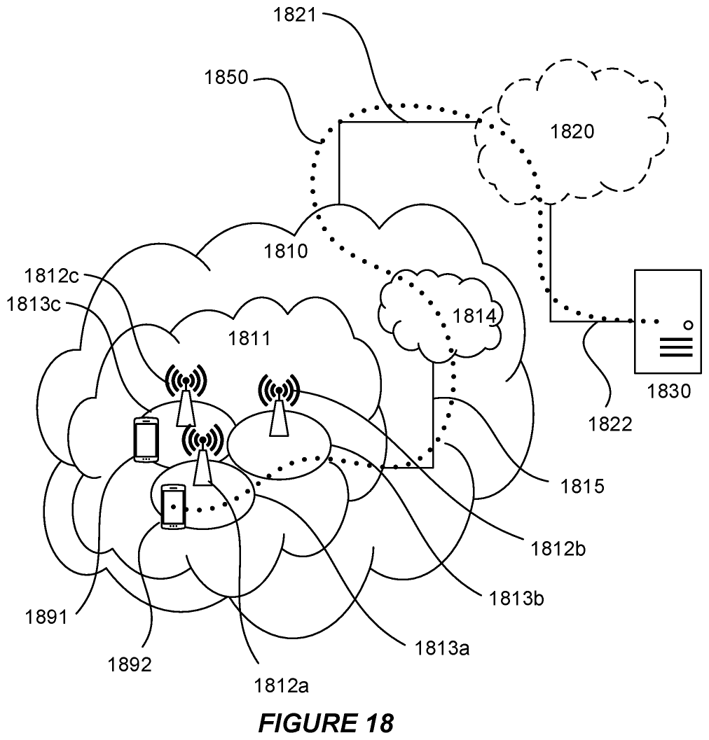

FIG. 18 illustrates a telecommunication network connected via an intermediate network to a host computer in accordance with some embodiments. In particular, with reference to FIG. 18, in accordance with an embodiment, a communication system includes telecommunication network 1810, such as a 3GPP-type cellular network, which comprises access network 1811, such as a radio access network, and core network 1814. Access network 1811 comprises a plurality of base stations 1812a, 1812b, 1812c, such as NBs, eNBs, gNBs or other types of wireless access points, each defining a corresponding coverage area 1813a, 1813b, 1813c. Each base station 1812a, 1812b, 1812c is connectable to core network 1814 over a wired or wireless connection 1815. A first UE 1891 located in coverage area 1813c is configured to wirelessly connect to, or be paged by, the corresponding base station 1812c. A second UE 1892 in coverage area 1813a is wirelessly connectable to the corresponding base station 1812a. While a plurality of UEs 1891, 1892 are illustrated in this example, the disclosed embodiments are equally applicable to a situation where a sole UE is in the coverage area or where a sole UE is connecting to the corresponding base station 1812.

Telecommunication network 1810 is itself connected to host computer 1830, which may be embodied in the hardware and/or software of a standalone server, a cloud-implemented server, a distributed server or as processing resources in a server farm. Host computer 1830 may be under the ownership or control of a service provider, or may be operated by the service provider or on behalf of the service provider. Connections 1821 and 1822 between telecommunication network 1810 and host computer 1830 may extend directly from core network 1814 to host computer 1830 or may go via an optional intermediate network 1820. Intermediate network 1820 may be one of, or a combination of more than one of, a public, private or hosted network; intermediate network 1820, if any, may be a backbone network or the Internet; in particular, intermediate network 1820 may comprise two or more sub-networks (not shown).

The communication system of FIG. 18 as a whole enables connectivity between the connected UEs 1891, 1892 and host computer 1830. The connectivity may be described as an over-the-top (OTT) connection 1850. Host computer 1830 and the connected UEs 1891, 1892 are configured to communicate data and/or signaling via OTT connection 1850, using access network 1811, core network 1814, any intermediate network 1820 and possible further infrastructure (not shown) as intermediaries. OTT connection 1850 may be transparent in the sense that the participating communication devices through which OTT connection 1850 passes are unaware of routing of uplink and downlink communications. For example, base station 1812 may not or need not be informed about the past routing of an incoming downlink communication with data originating from host computer 1830 to be forwarded (e.g., handed over) to a connected UE 1891. Similarly, base station 1812 need not be aware of the future routing of an outgoing uplink communication originating from the UE 1891 towards the host computer 1830.

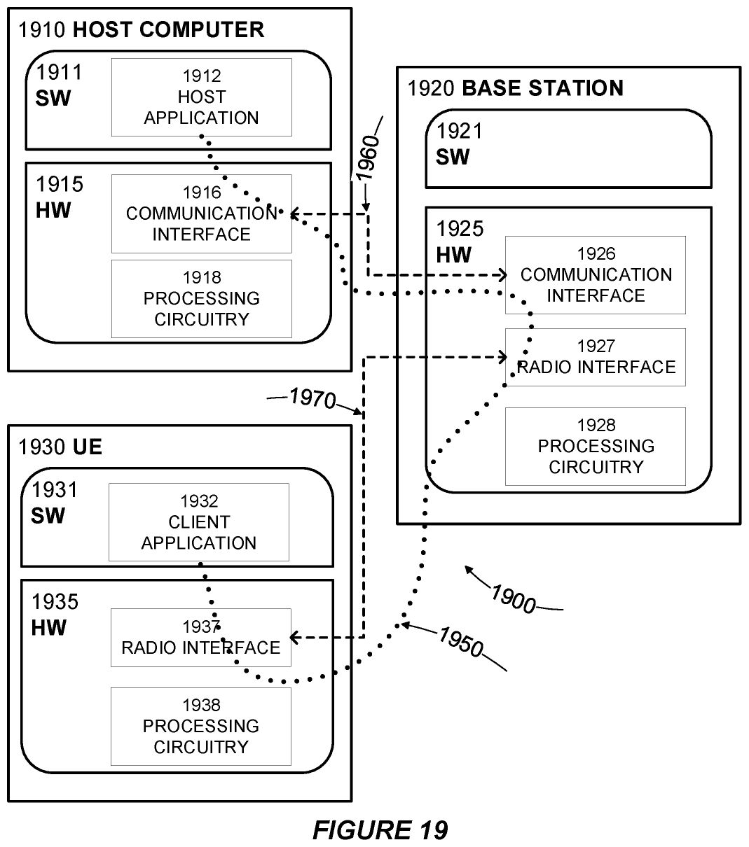

Example implementations, in accordance with an embodiment, of the UE, base station and host computer discussed in the preceding paragraphs will now be described with reference to FIG. 19. FIG. 19 illustrates host computer communicating via a base station with a user equipment over a partially wireless connection in accordance with some embodiments In communication system 1900, host computer 1910 comprises hardware 1915 including communication interface 1916 configured to set up and maintain a wired or wireless connection with an interface of a different communication device of communication system 1900. Host computer 1910 further comprises processing circuitry 1918, which may have storage and/or processing capabilities. In particular, processing circuitry 1918 may comprise one or more programmable processors, application-specific integrated circuits, field programmable gate arrays or combinations of these (not shown) adapted to execute instructions. Host computer 1910 further comprises software 1911, which is stored in or accessible by host computer 1910 and executable by processing circuitry 1918. Software 1911 includes host application 1912. Host application 1912 may be operable to provide a service to a remote user, such as UE 1930 connecting via OTT connection 1950 terminating at UE 1930 and host computer 1910. In providing the service to the remote user, host application 1912 may provide user data which is transmitted using OTT connection 1950.

Communication system 1900 further includes base station 1920 provided in a telecommunication system and comprising hardware 1925 enabling it to communicate with host computer 1910 and with UE 1930. Hardware 1925 may include communication interface 1926 for setting up and maintaining a wired or wireless connection with an interface of a different communication device of communication system 1900, as well as radio interface 1927 for setting up and maintaining at least wireless connection 1970 with UE 1930 located in a coverage area (not shown in FIG. 19) served by base station 1920. Communication interface 1926 may be configured to facilitate connection 1960 to host computer 1910. Connection 1960 may be direct or it may pass through a core network (not shown in FIG. 19) of the telecommunication system and/or through one or more intermediate networks outside the telecommunication system. In the embodiment shown, hardware 1925 of base station 1920 further includes processing circuitry 1928, which may comprise one or more programmable processors, application-specific integrated circuits, field programmable gate arrays or combinations of these (not shown) adapted to execute instructions. Base station 1920 further has software 1921 stored internally or accessible via an external connection.

Communication system 1900 further includes UE 1930 already referred to. Its hardware 1935 may include radio interface 1937 configured to set up and maintain wireless connection 1970 with a base station serving a coverage area in which UE 1930 is currently located. Hardware 1935 of UE 1930 further includes processing circuitry 1938, which may comprise one or more programmable processors, application-specific integrated circuits, field programmable gate arrays or combinations of these (not shown) adapted to execute instructions. UE 1930 further comprises software 1931, which is stored in or accessible by UE 1930 and executable by processing circuitry 1938. Software 1931 includes client application 1932. Client application 1932 may be operable to provide a service to a human or non-human user via UE 1930, with the support of host computer 1910. In host computer 1910, an executing host application 1912 may communicate with the executing client application 1932 via OTT connection 1950 terminating at UE 1930 and host computer 1910. In providing the service to the user, client application 1932 may receive request data from host application 1912 and provide user data in response to the request data. OTT connection 1950 may transfer both the request data and the user data. Client application 1932 may interact with the user to generate the user data that it provides.

It is noted that host computer 1910, base station 1920 and UE 1930 illustrated in FIG. 19 may be similar or identical to host computer 1830, one of base stations 1812a, 1812b, 1812c and one of UEs 1891, 1892 of FIG. 18, respectively. This is to say, the inner workings of these entities may be as shown in FIG. 19 and independently, the surrounding network topology may be that of FIG. 18.

In FIG. 19, OTT connection 1950 has been drawn abstractly to illustrate the communication between host computer 1910 and UE 1930 via base station 1920, without explicit reference to any intermediary devices and the precise routing of messages via these devices. Network infrastructure may determine the routing, which it may be configured to hide from UE 1930 or from the service provider operating host computer 1910, or both. While OTT connection 1950 is active, the network infrastructure may further take decisions by which it dynamically changes the routing (e.g., on the basis of load balancing consideration or reconfiguration of the network).

Wireless connection 1970 between UE 1930 and base station 1920 is in accordance with the teachings of the embodiments described throughout this disclosure. One or more of the various embodiments improve the performance of OTT services provided to UE 1930 using OTT connection 1950, in which wireless connection 1970 forms the last segment.

A measurement procedure may be provided for the purpose of monitoring data rate, latency and other factors on which the one or more embodiments improve. There may further be an optional network functionality for reconfiguring OTT connection 1950 between host computer 1910 and UE 1930, in response to variations in the measurement results. The measurement procedure and/or the network functionality for reconfiguring OTT connection 1950 may be implemented in software 1911 and hardware 1915 of host computer 1910 or in software 1931 and hardware 1935 of UE 1930, or both. In embodiments, sensors (not shown) may be deployed in or in association with communication devices through which OTT connection 1950 passes; the sensors may participate in the measurement procedure by supplying values of the monitored quantities exemplified above, or supplying values of other physical quantities from which software 1911, 1931 may compute or estimate the monitored quantities. The reconfiguring of OTT connection 1950 may include message format, retransmission settings, preferred routing etc.; the reconfiguring need not affect base station 1920, and it may be unknown or imperceptible to base station 1920. Such procedures and functionalities may be known and practiced in the art. In certain embodiments, measurements may involve proprietary UE signaling facilitating host computer 1910's measurements of throughput, propagation times, latency and the like. The measurements may be implemented in that software 1911 and 1931 causes messages to be transmitted, in particular empty or ‘dummy’ messages, using OTT connection 1950 while it monitors propagation times, errors etc.

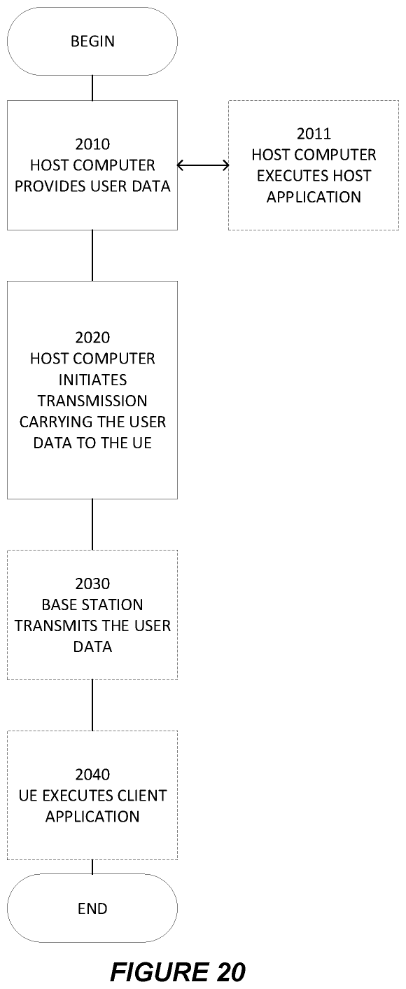

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 2010, the host computer provides user data. In substep 2011 (which may be optional) of step 2010, the host computer provides the user data by executing a host application. In step 2020, the host computer initiates a transmission carrying the user data to the UE. In step 2030 (which may be optional), the base station transmits to the UE the user data which was carried in the transmission that the host computer initiated, in accordance with the teachings of the embodiments described throughout this disclosure. In step 2040 (which may also be optional), the UE executes a client application associated with the host application executed by the host computer.

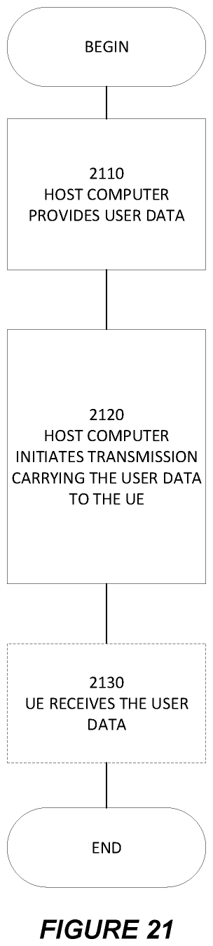

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In step 2110 of the method, the host computer provides user data. In an optional substep (not shown) the host computer provides the user data by executing a host application. In step 2120, the host computer initiates a transmission carrying the user data to the UE. The transmission may pass via the base station, in accordance with the teachings of the embodiments described throughout this disclosure. In step 2130 (which may be optional), the UE receives the user data carried in the transmission.

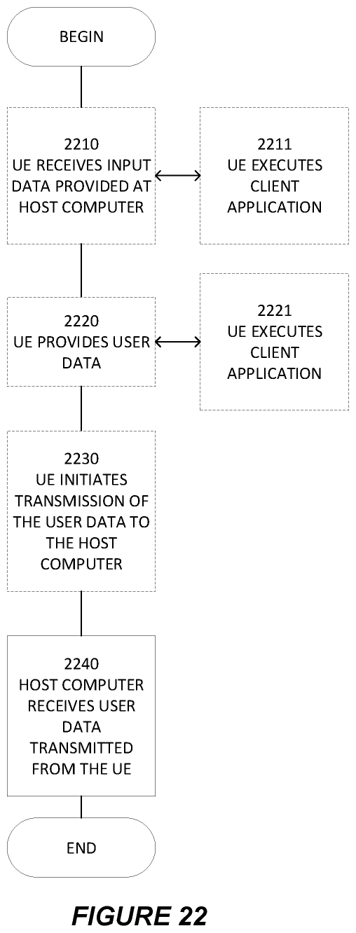

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In step 2210 (which may be optional), the UE receives input data provided by the host computer. Additionally or alternatively, in step 2220, the UE provides user data. In substep 2221 (which may be optional) of step 2220, the UE provides the user data by executing a client application. In substep 2211 (which may be optional) of step 2210, the UE executes a client application which provides the user data in reaction to the received input data provided by the host computer. In providing the user data, the executed client application may further consider user input received from the user. Regardless of the specific manner in which the user data was provided, the UE initiates, in substep 2230 (which may be optional), transmission of the user data to the host computer. In step 2240 of the method, the host computer receives the user data transmitted from the UE, in accordance with the teachings of the embodiments described throughout this disclosure.

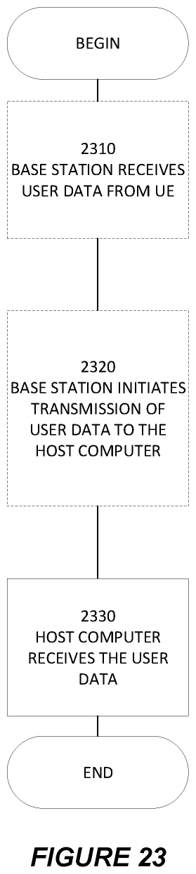

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In step 2310 (which may be optional), in accordance with the teachings of the embodiments described throughout this disclosure, the base station receives user data from the UE. In step 2320 (which may be optional), the base station initiates transmission of the received user data to the host computer. In step 2330 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Example embodiments of the techniques and apparatus described herein include, but are not limited to, the following enumerated examples:

### GROUP A EMBODIMENTS

A1. A method performed by a wireless device, the method comprising:
receiving, from a radio network node, signaling that indicates whether or not gapless message transmission is configured for random access on a link, wherein according to gapless message transmission a gap in time, if any, between an end of a transmission of a random access preamble and a start of a transmission of a payload is less than or equal to a maximum gap threshold.
   A2. The method of embodiment A1, further comprising performing random access on the link based on the received signaling.
   A3. The method of embodiment A2, wherein said performing comprises determining, based at least in part on the received signaling, whether or not to use gapless message transmission for random access on the link.
   A4. The method of embodiment A3, wherein said determining is also based on whether or not the wireless device is capable of gapless message transmission for random access.
   A5. The method of embodiment A4, wherein said performing comprises:
using gapless message transmission for random access on the link if the signaling indicates that gapless message transmission is configured for random access on the link and the wireless device is capable of gapless message transmission for random access; or
not using gapless message transmission for random access on the link if the signaling indicates that gapless message transmission is not configured for random access on the link or the wireless device is not capable of gapless message transmission for random access.
   A6. The method of any of embodiments A2-A5, wherein said performing comprises, based on the signaling indicating that gapless message transmission is not configured for random access on the link or based on the wireless device not being capable of gapless message transmission for random access:
transmitting a random access preamble for random access on the link;
receiving a random access response in response to the transmitted random access preamble; and
transmitting a payload after receiving the random access response.
   A7. The method of embodiment A6, wherein the transmitted random access preamble is specific for a 4-step random access procedure.
   A8. The method of embodiment A6, wherein the transmitted random access preamble is specific for a 2-step random access procedure.
   A9. The method of any of embodiments A1-A8, further comprising determining, based on the received signaling, whether to perform random access on the link.
   A10. The method of any of embodiments A1-A9, further comprising performing link selection based on the received signaling.
   A11. The method of embodiment A10, wherein performing link selection based on the received signaling comprises selecting, from one or more candidate links, a link on which to perform random access, according to link selection criteria that favors links in the following order:
a link with the best downlink signal measurement and on which gapless message transmission is configured for random access;
a link on which gapless message transmission is not configured for random access but which has the best downlink signal measurement and is configured for a 2-step random access procedure;
a link on which gapless message transmission is not configured for random access and which is not configured for a 2-step random access procedure, but which has the best downlink signal measurement.
   A12. The method of any of embodiments A1-A10, further comprising:
performing a signal measurement on the link;
based on the received signaling, determining how or whether to offset the signal measurement; and
based on the signal measurement, as offset or not according to said determining, deciding whether or not to perform random access on the link.
   A13. The method of embodiment A12, wherein said determining is also based on at least one of any one or more of:
a density of random access channel occasions on the link;
a density of random access channel occasions configured for 2-step random access on the link;
whether the link is configured with resources usable for both gapless message transmission and non-gapless message transmission;
whether the link is configured for 4-step random access and/or 2-step random access; and
whether the wireless device is capable of gapless message transmission for random access.
   A14. The method of any of embodiments A12-A13, further comprising receiving, from the radio network node, signaling indicating an offset to apply to a signal measurement performed on a link for which gapless message transmission is configured.
   A15. The method of any of embodiments A1-A14, wherein the link is a cell.
   A16. The method of any of embodiments A1-A14, wherein the link is a bandwidth part of a cell or a carrier.
   A17. The method of any of embodiments A1-A16, wherein the link is deployed on an unlicensed frequency carrier.
   A18. The method of any of embodiments A1-A17, further comprising, based on the received signaling, performing random access on the link using gapless message transmission, including transmitting both a random access preamble and a payload based on the same clear channel assessment.
   A19. The method of any of embodiments A1-A18, wherein the signaling comprises broadcasted system information.
   AA1. A method performed by a wireless device, the method comprising:
performing a signal measurement on a link;
determining, based on random access configuration of the link, how or whether to offset the signal measurement; and
based on the signal measurement, as offset or not according to said determining, deciding whether or not to perform random access on the link.
   AA2. The method of embodiment AA1, wherein the random access configuration includes whether or not gapless message transmission is configured for random access on the link.
   AA3. The method of any of embodiments AA1-AA2, wherein the random access configuration includes at least one of any one or more of:
a density of random access channel occasions on the link;
a density of random access channel occasions configured for 2-step random access on the link;
whether the link is configured with resources usable for both gapless message transmission and non-gapless message transmission;
whether the link is configured for 4-step random access and/or 2-step random access.
   AA4. The method of any of embodiments AA1-AA3, wherein the link is a cell.
   AA5. The method of any of embodiments AA1-AA4, wherein the link is a bandwidth part of a cell or a carrier.
   AA6. The method of any of embodiments AA1-AA5, wherein the link is deployed on an unlicensed frequency carrier.
   AA7. The method of any of embodiments AA1-AA6, further comprising receiving, from a radio network node, signaling indicating one or more offsets to apply to the signal measurement according to said determining.
   AA8. The method of any of embodiments AA1-AA7, further comprising performing random access on the link using gapless message transmission, including transmitting both a random access preamble and a payload based on the same clear channel assessment.
   AAA1. A method performed by a wireless device, the method comprising:
receiving, from a radio network node, signaling indicating one or more offsets to apply to a signal measurement performed on a link depending on a random access configuration of the link.
   AAA2. The method of embodiment AAA1, wherein the random access configuration includes whether or not gapless message transmission is configured for random access on the link.
   AAA3. The method of any of embodiments AAA1-AAA2, wherein the random access configuration includes at least one of any one or more of:
a density of random access channel occasions on the link;
a density of random access channel occasions configured for 2-step random access on the link;
whether the link is configured with resources usable for both gapless message transmission and non-gapless message transmission;
whether the link is configured for 4-step random access and/or 2-step random access.
   AAA4. The method of any of embodiments AAA1-AAA3, wherein the link is a cell.
   AAA5. The method of any of embodiments AAA1-AAA4, wherein the link is a bandwidth part of a cell or a carrier.
   AAA6. The method of any of embodiments AAA1-AAA5, wherein the link is deployed on an unlicensed frequency carrier.
   AAAA1. A method performed by a wireless device, the method comprising:
determining that no resources configured for random access on a link support a minimum gap requirement of the wireless device, wherein the minimum gap requirement is a minimum gap required in time between an end of a transmission of a random access preamble and a start of a transmission of a payload; and
based on said determining, transmitting a random access preamble using the resources configured for random access on the link, but waiting to transmit a payload until the wireless device receives a random access response in response to the random access preamble.
   AAAA2. The method of embodiment AAAA1, wherein the transmitted random access preamble is a 4-step random access preamble.
   AAAA3. The method of embodiment AAAA2, further comprising selecting to perform a 2-step random access procedure for random access on the link, wherein said determining is performed after said selecting.
   AAAA4. The method of embodiment AAA1, wherein the transmitted random access preamble is a 2-step random access preamble.
   AAAA5. The method of embodiment AAAA4, wherein the random access response is a fallback random access response.
   AAAA6. The method of any of embodiments AAAA4-AAAA5, further comprising:
selecting to perform a 4-step random access procedure for random access on the link;
after said selecting, determining that no resources are configured on the link for a 4-step random access procedure;
selecting to transmit a 2-step random access preamble based on said determining that no resources are configured on the link for a 4-step random access procedure; and
after selecting to transmit a 2-step random access preamble, determining whether resources configured for random access on the link support the minimum gap requirement of the wireless device.
   AAAA7. The method of any of embodiments AAAA4-AAAA5, further comprising selecting a random access preamble resource in which to transmit a random access preamble, irrespective of whether the random access preamble resource is configured for a 2-step random access preamble or a 4-step random access preamble, wherein said determining is performed after selecting a random access preamble resource configured for a 2-step random access preamble.
   AAAA8. The method of any of embodiments AAAA4-AAAA5, further comprising selecting a random access preamble resource configured for a 2-step random access preamble, wherein said determining is performed after said selecting.
   AAAA9. The method of any of any of embodiments AAAA1-AAAA8, wherein said determining that no resources configured for random access on the link support the minimum gap requirement of the wireless device comprises, for each combination of a random access preamble resource and a payload resource configured for random access on the link, determining that a gap in time between an end of the random access preamble resource and a start of the payload resource is less than the minimum gap requirement of the wireless device.
   AAAA10. The method of any of embodiments AAAA1-AAAA9, wherein waiting to transmit a payload until the wireless device receives a random access response in response to the random access preamble comprises discarding a payload prepared for transmission as part of a 2-step random access procedure.
   AAAA11. The method of any of embodiments AAAA1-AAAA10, wherein the link is a cell.
   AAAA12. The method of any of embodiments AAAA1-AAAA10, wherein the link is a bandwidth part of a cell or a carrier.
   AAAA13. The method of any of embodiments AAAA1-AAAA12, wherein the link is deployed on an unlicensed frequency carrier.
   AAAAA1. A method performed by a wireless device, the method comprising:
determining that no resources configured for random access on a link support a minimum gap requirement of the wireless device, wherein the minimum gap requirement is a minimum gap required in time between an end of a transmission of a random access preamble and a start of a transmission of a payload; and
based on said determining, selecting to perform random access on a different link, or delaying random access on the link until resources configured for random access on the link support the minimum gap requirement of the wireless device.
   AAAAAA1. A method performed by a wireless device, the method comprising:
determining whether and/or which resources configured for random access on a link support a minimum gap requirement of the wireless device and/or a maximum gap requirement for gapless message transmission, wherein the minimum gap requirement is a minimum gap required in time between an end of a transmission of a random access preamble and a start of a transmission of a payload, and wherein according to the maximum gap requirement a gap in time, if any, between an end of a transmission of a random access preamble and a start of a transmission of a payload must be less than or equal to a maximum gap threshold;
based on said determining, deciding whether and/or how to perform random access on the link; and
performing or not performing random access on the link according to said deciding.
   AAAAAA2. The method of embodiment AAAAAA1, wherein said deciding comprises selecting which resources to use for performing random access on the link, and wherein said performing comprises performing random access on the link using the selected resources.
   AAAAAA3. The method of any of embodiments AAAAAA1-AAAAAA2, wherein said deciding comprises selecting which random access preamble to use for performing random access on the link, and wherein said performing comprises transmitting the selected random access preamble.
   AAAAAA4. The method of any of embodiments AAAAAA1-AAAAAA3, wherein said deciding comprises deciding whether and/or how to use gapless message transmission for random access on the link, and wherein said performing or not performing comprises using or not using gapless message transmission for random access on the link according to said deciding.
   AAAAAA5. The method of any of embodiments AAAAAA1-AAAAAA4, wherein said deciding comprises deciding whether to use a 2-step procedure or a 4-step procedure for random access on the link, and wherein said performing or not performing comprises using the 2-step procedure or the 4-step procedure for random access on the link according to said deciding.
   AAAAAA6. The method of any of embodiments AAAAAA1-AAAAAA8, wherein the link is a cell.
   AAAAAA7. The method of any of embodiments AAAAAA1-AAAAAA8, wherein the link is a bandwidth part of a cell or a carrier.
   AAAAAA8. The method of any of embodiments AAAAAA1-AAAAAA7, wherein the link is deployed on an unlicensed frequency carrier.

AA. The method of any of the previous embodiments, further comprising:
providing user data; and
forwarding the user data to a host computer via the transmission to a base station.

### GROUP B EMBODIMENTS

B1. A method performed by a radio network node, the method comprising:
transmitting, from the radio network node to a wireless device, signaling that indicates whether or not gapless message transmission is configured for random access on a link, wherein according to gapless message transmission a gap in time, if any, between an end of a transmission of a random access preamble and a start of a transmission of a payload is less than or equal to a maximum gap threshold.
   B2. The method of embodiment 1, further comprising transmitting, from the radio network node to the wireless device, signaling indicating an offset that the wireless device is to apply to a signal measurement performed on a link for which gapless message transmission is configured.
   B3. The method of any of embodiments B1-B2, wherein the link is a cell.
   B4. The method of any of embodiments B1-B2, wherein the link is a bandwidth part of a cell or a carrier.
   B5. The method of any of embodiments B1-B4, wherein the link is deployed on an unlicensed frequency carrier.
   B6. The method of any of embodiments B1-B5, wherein the signaling comprises broadcasted system information.
   BB1. A method performed by a radio network node, the method comprising:
transmitting, from the radio network node to a wireless device, signaling indicating one or more offsets that the wireless device is to apply to a signal measurement performed on a link depending on a random access configuration of the link.
   BB2. The method of embodiment BB1, wherein the random access configuration includes whether or not gapless message transmission is configured for random access on the link.
   BB3. The method of any of embodiments BB1-BB2, wherein the random access configuration includes at least one of any one or more of:
a density of random access channel occasions on the link;
a density of random access channel occasions configured for 2-step random access on the link;
whether the link is configured with resources usable for both gapless message transmission and non-gapless message transmission;
whether the link is configured for 4-step random access and/or 2-step random access.
   BB4. The method of any of embodiments BB1-BB3, wherein the link is a cell.
   BB5. The method of any of embodiments BB1-BB4, wherein the link is a bandwidth part of a cell or a carrier.
   BB6. The method of any of embodiments BB1-BB5, wherein the link is deployed on an unlicensed frequency carrier.
   BBB1. A method performed by a radio network node, the method comprising:
determining whether or not a wireless device is capable of gapless message transmission for random access on a link, wherein according to gapless message transmission a gap in time, if any, between an end of a transmission of a random access preamble and a start of a transmission of a payload is less than or equal to a maximum gap threshold; and
based on whether or not the wireless device is capable of gapless message transmission according to said determining, configuring the wireless device to perform random access on the link.
   BBB2. The method of embodiment BBB1, further comprising receiving signaling indicating whether or not the wireless device is capable of gapless message transmission, and wherein said determining is based on the received signaling.
   BBB3. The method of embodiment BBB2, wherein the signaling is received from the wireless device.
   BBB4. The method of embodiment BBB2, wherein the signaling is received from another network node.
   BBB5. The method of embodiment BBB4, wherein the signaling comprises a handover request message or a secondary node addition request message.
   BBB6. The method of any of embodiments BBB1-BBB5, wherein said determining comprises deducing whether or not the wireless device is capable of gapless message transmission based respectively on whether or not the wireless device uses gapless message transmission for random access on the link.
   BBB7. The method of any of embodiments BBB1-BBB6, wherein said configuring comprises configuring the wireless device with resources for gapless message transmission or resources for non-gapless message transmission for random access on the link, depending respectively on whether or not the wireless device supports or does not support gapless message transmission.
   BBB8. The method of any of embodiments BBB1-BBB7, wherein said configuring comprises transmitting dedicated signaling to the wireless device indicating said configuring of the wireless device.
   BBB9. The method of embodiment BBB8, wherein the dedicated signaling triggers the wireless device to perform a mobility procedure.

BB10. The method of embodiment BBB9, wherein the mobility procedure is a handover, a primary secondary cell group cell (PSCell) addition, a PSCell change, or a secondary cell (SCell) addition.

BBB11. The method of embodiment BBB8, wherein the dedicated signaling triggers the wireless device to start monitoring a condition for execution of a conditional mobility procedure.
BBB12. The method of embodiment BBB11, wherein the conditional mobility procedure is a conditional handover, a conditional primary secondary cell group cell (PSCell) addition, a conditional PSCell change, or a conditional secondary cell (SCell) addition.
BBB13. The method of any of embodiments BBB1-BBB12, wherein said configuring comprises transmitting, via another radio network node, signaling to the wireless device indicating said configuring of the wireless device.
BBB14. The method of embodiment BBB6, wherein said deducing comprises performing energy detection to determine whether or not the wireless device transmits a payload using gapless message transmission for random access on the link.
BB. The method of any of the previous embodiments, further comprising:
obtaining user data; and
forwarding the user data to a host computer or a wireless device.

### GROUP C EMBODIMENTS

C1. A wireless device configured to perform any of the steps of any of the Group A embodiments.
C2. A wireless device comprising processing circuitry configured to perform any of the steps of any of the Group A embodiments.
C3. A wireless device comprising:
communication circuitry; and
processing circuitry configured to perform any of the steps of any of the Group A embodiments.
   C4. A wireless device comprising:
processing circuitry configured to perform any of the steps of any of the Group A embodiments; and
power supply circuitry configured to supply power to the wireless device.
   C5. A wireless device comprising:
processing circuitry and memory, the memory containing instructions executable by the processing circuitry whereby the wireless device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a wireless device, causes the wireless device to carry out the steps of any of the Group A embodiments.
   C8. A carrier containing the computer program of embodiment C7, wherein the carrier is one of an electronic signal, optical signal, radio signal, or computer readable storage medium.
   C9. A radio network node configured to perform any of the steps of any of the Group B embodiments.
   C10. A radio network node comprising processing circuitry configured to perform any of the steps of any of the Group B embodiments.
   C11. A radio network node comprising:
communication circuitry; and
processing circuitry configured to perform any of the steps of any of the Group B embodiments.
   C12. A radio network node comprising:
processing circuitry configured to perform any of the steps of any of the Group B embodiments;
power supply circuitry configured to supply power to the radio network node.
   C13. A radio network node comprising:
processing circuitry and memory, the memory containing instructions executable by the processing circuitry whereby the radio network node is configured to perform any of the steps of any of the Group B embodiments.
   C14. The radio network node of any of embodiments C9-C13, wherein the radio network node is a base station.
   C15. A computer program comprising instructions which, when executed by at least one processor of a radio network node, causes the radio network node to carry out the steps of any of the Group B embodiments.
   C16. The computer program of embodiment C14, wherein the radio network node is a base station.
   C17. A carrier containing the computer program of any of embodiments C15-C16, wherein the carrier is one of an electronic signal, optical signal, radio signal, or computer readable storage medium.

### GROUP D EMBODIMENTS

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

1.-27. (canceled)

28. A method performed by a wireless device, the method comprising:
determining that no resources configured for random access on a link support a minimum gap requirement of the wireless device, wherein the minimum gap requirement is a capability of the wireless device for supporting a minimum gap in time between an end of a transmission of a random access preamble and a start of a transmission of a payload on a Physical Uplink Shared Channel, PUSCH, and wherein the link is deployed on an unlicensed frequency carrier; and
based on said determining:
transmitting a random access preamble using the resources configured for random access on the link, but waiting to transmit a payload until the wireless device receives a random access response in response to the random access preamble; or
delaying random access on the link until resources configured for random access on the link support the minimum gap requirement of the wireless device; or
selecting to perform random access on a different link.

29. The method of claim 28, wherein said transmitting, delaying, or selecting comprises transmitting a random access preamble using the resources configured for random access on the link, but waiting to transmit a payload until the wireless device receives a random access response in response to the random access preamble.

30. The method of claim 29, wherein waiting to transmit a payload until the wireless device receives a random access response in response to the random access preamble comprises discarding a payload prepared for transmission as part of a 2-step random access procedure.

31. The method of claim 29, wherein said determining comprises determining that no resources configured for random access on the link support a minimum gap requirement needed for the wireless device to perform a 2-step random access procedure, and wherein said transmitting comprises transmitting, based on said determining, a 4-step random access preamble.

32. The method of claim 29, wherein the transmitted random access preamble is a 2-step random access preamble and the random access response is a fallback random access response.

33. The method of claim 32, further comprising:
selecting to perform a 4-step random access procedure for random access on the link;
after selecting to perform the 4-step random access procedure, determining that no resources are configured on the link for a 4-step random access procedure;
selecting to transmit a 2-step random access preamble based on said determining that no resources are configured on the link for a 4-step random access procedure; and
after selecting to transmit a 2-step random access preamble, determining whether resources configured for random access on the link support the minimum gap requirement of the wireless device.

34. The method of claim 29, further comprising selecting a random access preamble resource in which to transmit a random access preamble, irrespective of whether the random access preamble resource is configured for a 2-step random access preamble or a 4-step random access preamble, wherein said determining is performed after selecting a random access preamble resource configured for a 2-step random access preamble.

35. The method of claim 29, further comprising selecting a random access preamble resource configured for a 2-step random access preamble, wherein said determining is performed after said selecting.

36. The method of claim 28, wherein said determining that no resources configured for random access on the link support the minimum gap requirement of the wireless device comprises, for each combination of a random access preamble resource and a payload resource configured for random access on the link, determining that a gap in time between an end of the random access preamble resource and a start of the payload resource is less than the minimum gap requirement of the wireless device.

37. A wireless device comprising:
communication circuitry; and
processing circuitry configured to:
determine that no resources configured for random access on a link support a minimum gap requirement of the wireless device, wherein the minimum gap requirement is a capability of the wireless device for supporting a minimum gap in time between an end of a transmission of a random access preamble and a start of a transmission of a payload on a Physical Uplink Shared Channel, PUSCH, and wherein the link is deployed on an unlicensed frequency carrier; and
based on determining that no resources configured for random access on the link support the minimum gap requirement of the wireless device:
transmit a random access preamble using the resources configured for random access on the link, but waiting to transmit a payload until the wireless device receives a random access response in response to the random access preamble; or
delay random access on the link until resources configured for random access on the link support the minimum gap requirement of the wireless device; or
select to perform random access on a different link.

38. The wireless device of claim 37, wherein said transmitting, delaying, or selecting comprises transmitting a random access preamble using the resources configured for random access on the link, but waiting to transmit a payload until the wireless device receives a random access response in response to the random access preamble.

39. The wireless device of claim 38, wherein waiting to transmit a payload until the wireless device receives a random access response in response to the random access preamble comprises discarding a payload prepared for transmission as part of a 2-step random access procedure.

40. The wireless device of claim 38, wherein said determining comprises determining that no resources configured for random access on the link support a minimum gap requirement needed for the wireless device to perform a 2-step random access procedure, and wherein said transmitting comprises transmitting, based on said determining, a 4-step random access preamble.

41. The wireless device of claim 38, wherein the transmitted random access preamble is a 2-step random access preamble and the random access response is a fallback random access response.

42. The wireless device of claim 41, further comprising:
selecting to perform a 4-step random access procedure for random access on the link;
after selecting to perform the 4-step random access procedure, determining that no resources are configured on the link for a 4-step random access procedure;
selecting to transmit a 2-step random access preamble based on said determining that no resources are configured on the link for a 4-step random access procedure; and
after selecting to transmit a 2-step random access preamble, determining whether resources configured for random access on the link support the minimum gap requirement of the wireless device.

43. The wireless device of claim 38, further comprising selecting a random access preamble resource in which to transmit a random access preamble, irrespective of whether the random access preamble resource is configured for a 2-step random access preamble or a 4-step random access preamble, wherein said determining is performed after selecting a random access preamble resource configured for a 2-step random access preamble.

44. The wireless device of claim 38, further comprising selecting a random access preamble resource configured for a 2-step random access preamble, wherein said determining is performed after said selecting.

45. The wireless device of claim 37, wherein said determining that no resources configured for random access on the link support the minimum gap requirement of the wireless device comprises, for each combination of a random access preamble resource and a payload resource configured for random access on the link, determining that a gap in time between an end of the random access preamble resource and a start of the payload resource is less than the minimum gap requirement of the wireless device.

46. The wireless device of claim 37, wherein said transmitting, delaying, or selecting comprises said delaying or said selecting.

47. A computer-readable storage medium on which is stored instructions which, when executed by at least one processor of a wireless device, causes the wireless device to:
make a determination that no resources configured for random access on a link support a minimum gap requirement of the wireless device, wherein the minimum gap requirement is a capability of the wireless device for supporting a minimum gap in time between an end of a transmission of a random access preamble and a start of a transmission of a payload on a Physical Uplink Shared Channel, PUSCH, and wherein the link is deployed on an unlicensed frequency carrier; and
based on said determination:
transmit a random access preamble using the resources configured for random access on the link, but wait to transmit a payload until the wireless device receives a random access response in response to the random access preamble; or
delay random access on the link until resources configured for random access on the link support the minimum gap requirement of the wireless device; or
select to perform random access on a different link.
